(19) United States
(12) Patent Application Publication
(10) Pub. No.: US 2025/0212240 A1
(43) Pub. Date: Jun. 26, 2025

(54) APPARATUS AND METHODS FOR PROVIDING COORDINATED RESOURCE AVAILABILITY INFORMATION

(71) Applicant: NEWRACOM, Inc., Irvine, CA (US)

(72) Inventors: Yeon-Geun LIM, Seoul (KR); Si-Chan NOH, Seoul (KR); Joonsoo LEE, Seoul (KR)

(73) Assignee: NEWRACOM, Inc., Irvine, CA (US)

(21) Appl. No.: 18/983,141

(22) Filed: Dec. 16, 2024

Related U.S. Application Data
(60) Provisional application No. 63/612,498, filed on Dec. 20, 2023.

(51) Int. Cl. H04W 72/50; H04W 72/0446

(52) U.S. Cl. CPC H04W 72/535; H04W 72/0446

(57) ABSTRACT

An embodiment is a method performed by a shared access point (AP) to provide coordinated frequency resource information to a sharing AP. The method includes obtaining frequency resource availability information for one or more stations (STAs) that are associated with the shared AP, generating the coordinated frequency resource information based on aggregating the obtained frequency resource availability information for the one or more STAs and frequency resource availability information for the shared AP, generating a control frame that includes an aggregated control (A-control) field that includes the coordinated frequency resource availability information, and transmitting the control frame to the sharing AP.

### CROSS-REFERENCE TO RELATED APPLICATION

This application claims the benefit of U.S. Provisional Application No. 63/612,498 filed Dec. 20, 2023, titled, “Apparatus and methods for bandwidth query report in beyond IEEE 802.11be networks,” which is hereby incorporated by reference.

### TECHNICAL FIELD

The present disclosure generally relates to wireless communications, and more specifically, relates to providing coordinated resource availability information in a wireless network.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

The IEEE 802.11bn (Ultra High Reliability, UHR) working group has been established with the aim of improving reliability, throughput, latency, and energy efficiency in wireless networks. Relay technology is being considered as a candidate technology to help improve the rate vs. range performance in future wireless networks. With relay technology, an access point (AP) may communicate with destination stations (dSTAs) via a relay station (STA), and vice versa.

Unlink a traditional non-relay STA, a relay STA may not have the ability to allocate downlink/uplink (DL/UL) resources. Thus, for multi-user (MU) operations via a relay STA, the AP is responsible for allocating the appropriate resource units (RUs) for each dSTA. For the AP to appropriately allocate DL/UL resources to the dSTAs, the AP needs to know the subchannel availability (e.g., the availability of 20 MHz subchannels) at each dSTA.

Also, in UHR, transmission opportunity (TXOP) sharing in certain 20 MHz subchannels has been considered for multi-AP systems (sometimes referred to as M-AP systems). With TXOP sharing, a first AP (which may be referred to as a sharing AP) may share a portion of its TXOP with a second AP (which may be referred to as a shared AP). If the availability of each 20 MHz subchannel of the shared AP and that of the STAs that are associated with the shared AP are not aligned, there is a chance that the shared AP cannot fully schedule transmissions for its associated STAs during the shared TXOP. Also, the resource utilization at the sharing AP and the shared AP during the shared TXOP may not be optimized.

In the IEEE 802.11ax wireless networking standard (also referred to as High Efficiency, HE) and the IEEE 802.11be wireless networking standard (also referred to as Extremely High Throughput, EHT), a non-AP STA is able to determine the availability of each 20 MHz subchannel at the STA based on performing a per-20 MHz energy detection (ED)-based clear channel assessment (CCA) and is able to report the availability of each 20 MHz subchannel at the STA to the AP by transmitting a bandwidth query report (BQR) to the AP. However, the existing BQR mechanism has at least the following drawbacks. First, in a relay system, the AP cannot know the availability of each subchannel at each dSTA, making it difficult for the AP to appropriately allocate DL/UL MU resources for the dSTAs. Second, in a multi-AP system, the sharing AP cannot know the availability of each subchannel at the STAs that are associated with the shared AP, making it difficult for the sharing AP to appropriately allocate TXOP resources for the shared AP.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a communication sequence in a relay system when an access point (AP) triggers bandwidth query report poll (BQRP) and solicits coordinated bandwidth query report (CBQR) information for downlink (DL) multi-user (MU) transmission via a relay STA when the relay STA can transmit trigger frames, according to some embodiments.

FIG. 11 is a diagram showing a communication sequence in a relay system when an AP solicits CBQR information for UL MU transmission via a relay STA when the relay STA can transmit trigger frames, according to some embodiments.

FIG. 12 is a diagram showing a communication sequence in a relay system when CBQR is unsolicited for UL MU transmission via a relay STA when the relay STA can transmit trigger frames, according to some embodiments.

FIG. 13 is a diagram showing a communication sequence in a relay system when an AP triggers BQRP and solicits CBQR information for DL MU transmission via a relay STA when the relay STA does not transmit trigger frames, according to some embodiments.

FIG. 14 is a diagram showing a communication sequence in a relay system when an AP solicits CBQR for UL MU transmission via a relay STA when the relay STA does not transmit trigger frames, according to some embodiments.

FIG. 15 is a diagram showing a communication sequence in a relay system when CBQR is unsolicited for UL MU transmission via a relay STA when the relay STA does not transmit trigger frames, according to some embodiments.

FIG. 16 is a diagram showing a communication sequence in a multi-AP system when a sharing AP triggers BQRP and solicits CBQR information, according to some embodiments.

FIG. 17 is a diagram showing a communication sequence in a multi-AP system when a sharing AP solicits CBQR, according to some embodiments.

FIG. 18 is a diagram showing a communication sequence in a multi-AP system when CBQR is unsolicited, according to some embodiments.

FIG. 19 is a flow diagram of a method for providing coordinated frequency resource information to a sharing AP, according to some embodiments.

FIG. 20 is a flow diagram of a method for providing coordinated frequency resource availability information to a sharing AP, according to some embodiments.

FIG. 21 is a flow diagram of a method for allocating frequency resources for a shared AP for an upcoming transmission opportunity (TXOP) owned by a sharing AP, according to some embodiments.

FIG. 22 is a flow diagram of a method for providing coordinated frequency resource availability information to a sharing AP, according to some embodiments.

FIG. 23 is a flow diagram of a method for implicitly determining coordinated frequency resource availability information provided by a shared AP, according to some embodiments.

### DETAILED DESCRIPTION

The present disclosure generally relates to wireless communications, and more specifically, relates to providing coordinated resource availability information in a wireless network.

To help improve the rate-vs-range performance in a relay system, the present disclosure describes techniques for a relay station (STA) to provide frequency resource availability information (e.g., subchannel availability information) for destination STAs (dSTAs) to the access point (AP). Also, to help improve the network throughput in a multi-AP system, the present disclosure describes techniques for a shared AP to provide frequency resource availability information (e.g., subchannel availability information) for STAs that are associated with the shared AP to the sharing AP.

In a relay system, the relay STA may aggregate frequency resource availability information for the dSTAs and provide this information to the AP. In a multi-AP system, the shared AP may aggregate frequency resource availability information for STAs that are associated with the shared AP and provide this information to the AP. The aggregated frequency resource availability information may be referred to herein as coordinated frequency resource availability information. Coordinated frequency resource availability information may include coordinated subchannel availability information, coordinated maximum available bandwidth information, and/or coordinated punctured channel information. The present disclosure describes various formats in which coordinated frequency resource availability information can be provided and various protocols for requesting and providing coordinated frequency resource availability information in both a relay system and a multi-AP system.

According to some embodiments, in a multi-AP system, a shared AP obtains frequency resource availability information for one or more STAs that are associated with the shared AP. The shared AP may then generate coordinated frequency resource information based on aggregating the obtained frequency resource availability information for the one or more STAs and frequency resource availability information for the shared AP. The shared AP may then generate a frame that includes a field (e.g., an aggregated control (A-control) field) that includes the coordinated frequency resource availability information and transmit the frame to the sharing AP.

According to some embodiments, a sharing AP transmits a first frame to the shared AP that solicits coordinated frequency resource availability information. The shared AP may generate coordinated frequency resource availability information based on aggregating frequency resource availability information for one or more STAs that are associated with the shared AP and frequency resource availability information for the shared AP. Responsive to receiving the first frame, the shared AP may transmit a solicited coordinated frequency resource availability report frame to the sharing AP that includes the coordinated frequency resource availability information. The sharing AP may then determine the frequency resources to allocate for the shared AP for an upcoming transmission opportunity (TXOP) based on the coordinated frequency resource availability information included in the solicited coordinated frequency resource availability report frame and transmit a second frame to the shared AP that includes information regarding the frequency resources allocated for the shared AP for the upcoming TXOP.

In an embodiment, a sharing AP can implicitly determine the coordinated frequency resource availability information based on a frame received from a shared AP. For example, a shared AP may transmit a multi-user request frame (e.g., a multi-user request-to-send (MU-RTS) frame) to a first STA and a second STA associated with the shared AP, wherein the multi-user request frame indicates that the first STA is assigned to a first set of subchannels and the second STA is assigned to a second set of subchannels having more subchannels than the first set of subchannels. The shared AP may then determine which subchannels in the first set of subchannels are available at the first STA and which subchannels in the second set of subchannels are available at the second STA based on response frames (e.g., clear-to-send (CTS) frames) received from the first STA and the second STA as a response to the multi-user request frame. The shared AP may then transmit a frame to a sharing AP in subchannels that are available at the shared AP, the first STA, and the second STA. Upon receiving the frame, the sharing AP may determine which subchannels in the first set of subchannels are available at the first STA associated with the shared AP and which subchannels in the second set of subchannels are available at the second STA associated with the shared AP based on the frame. The sharing AP may then implicitly determine the coordinated frequency resource availability information based on which subchannels in the first set of subchannels are available at the first STA and which subchannels in the second set of subchannels are available at the second STA.

The techniques described herein allow a STA (e.g., a relay STA or a shared AP) to provide information regarding the availability of each subchannel at other STAs (e.g., dSTAs or STAs that are associated with the shared AP) to another STA (e.g., an associated AP of the relay STA or a sharing AP). By using the techniques described herein, the AP in a relay system can allocate MU resources in a more efficient manner (e.g., so that resources are not wasted or underutilized). This improves the rate-vs-range performance of relay operations in the relay system Also, by using the techniques described herein, a sharing AP in a multi-AP system can allocate resources for a shared TXOP in a more efficient manner (e.g., so that resources are not wasted or underutilized). This improves network throughput in the multi-AP system.

For purposes of illustration, various embodiments are described herein in the context of wireless networks that are based on IEEE 802.11 wireless networking standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and descriptions are to be regarded as illustrative in nature and not restrictive. Like reference numerals designate like elements throughout the specification.

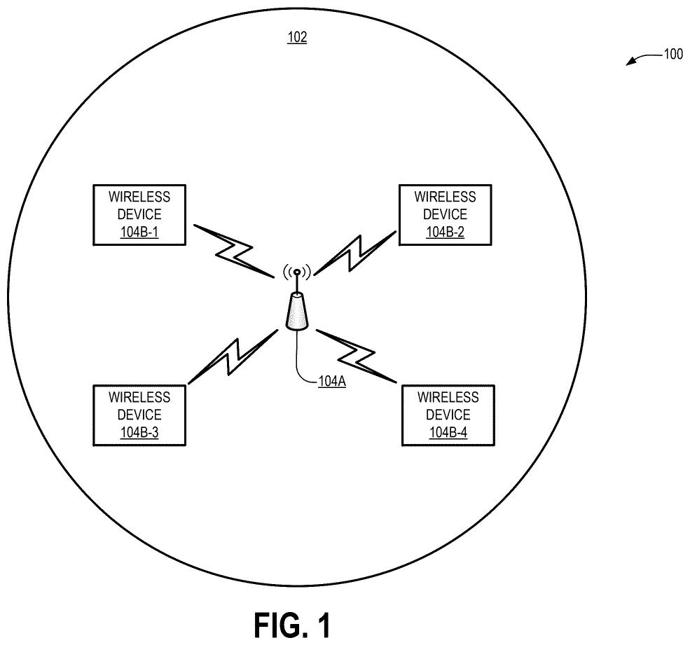

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

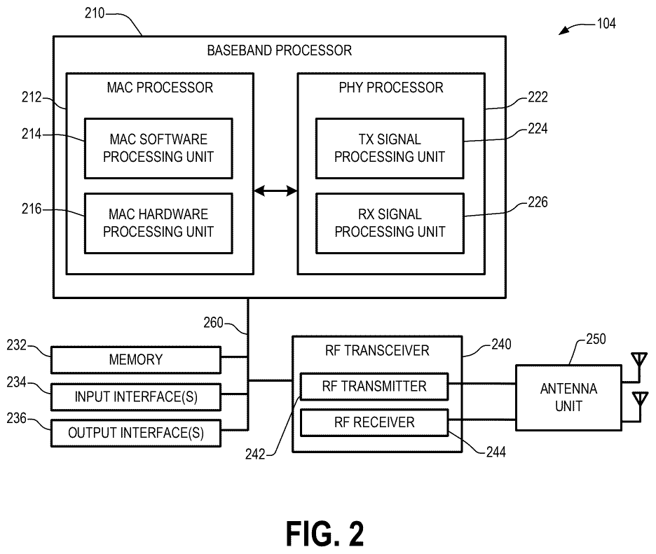

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programming instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more design costs, manufacturing costs, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

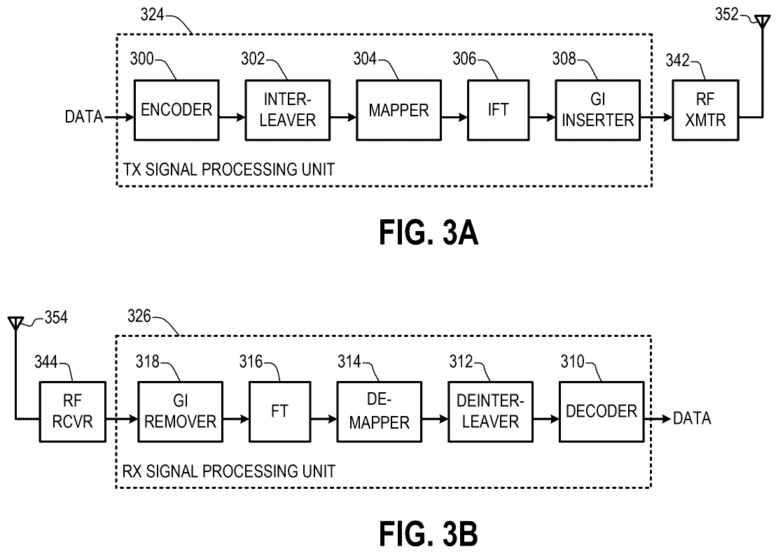

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of Os or Is. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for the sake of completeness and brevity, refer to OFDM-based 802.11 technology. Unless otherwise indicated, a station refers to a non-AP STA.

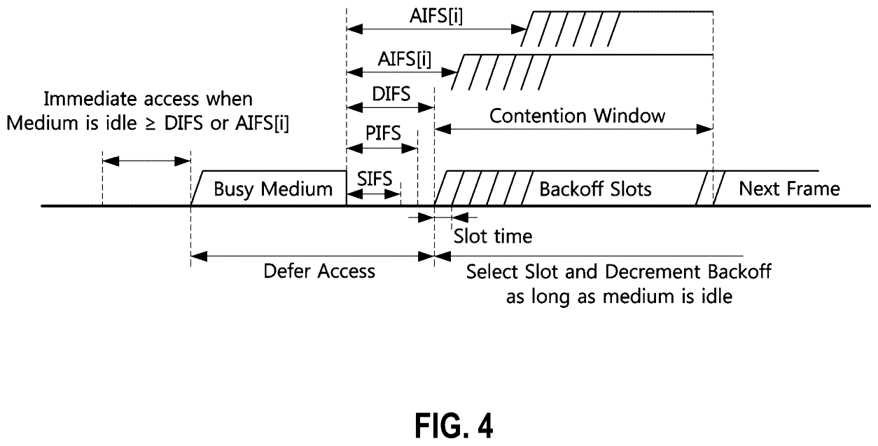

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrease the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

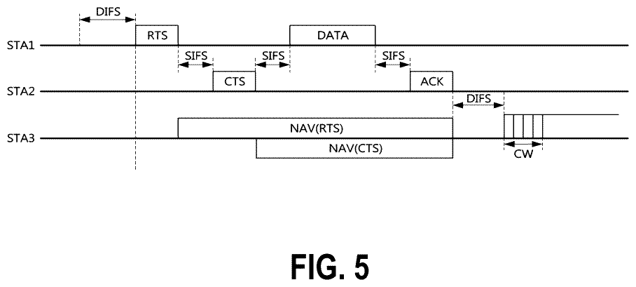

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

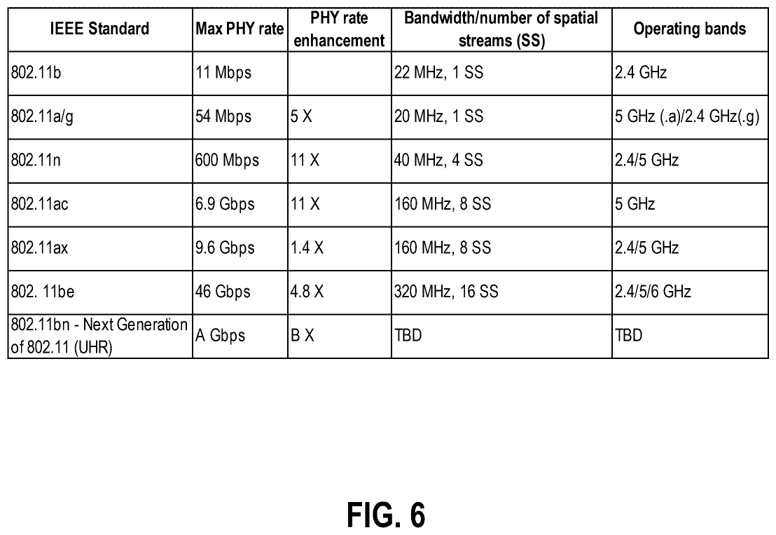

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

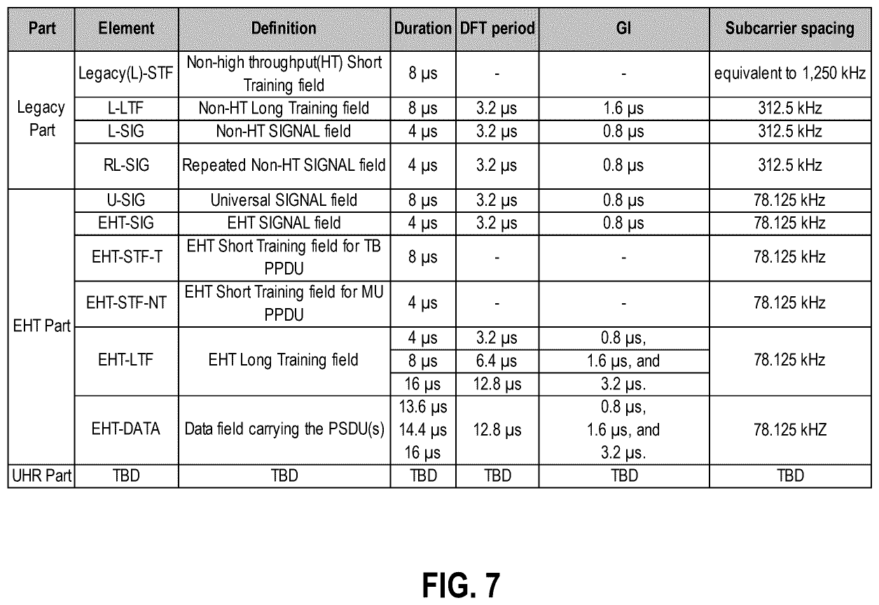

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

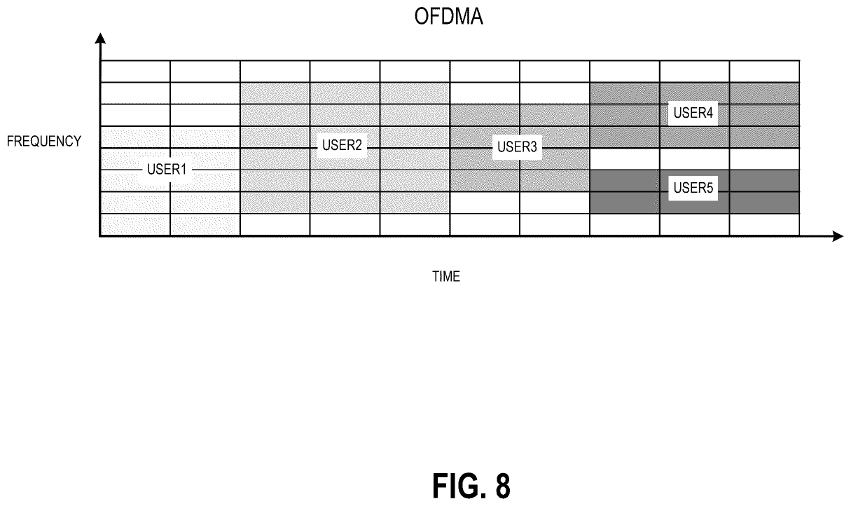

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

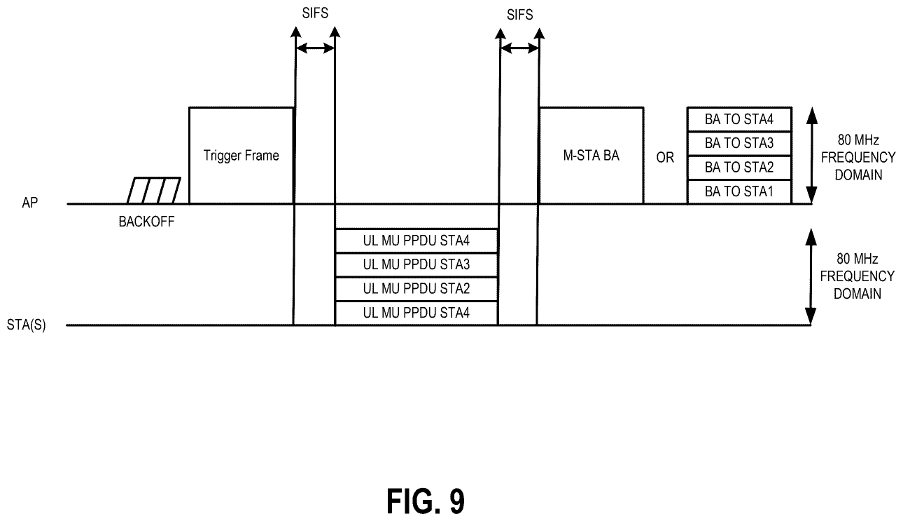

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

For MU operations, the AP's knowledge of the availability of each 20 MHz subchannel at each STA can assist the AP in appropriately allocating DL/UL MU resources for the STAs. In the IEEE 802.11ax wireless networking standard (also referred to as high efficiency (“HE”)) and the IEEE 802.11be wireless networking standard (also referred to as extremely high throughput (“EHT”)), even though each STA can transmit a clear-to-send (CTS) frame in different channels in response to receiving a multi-user request-to-send (MU-RTS) frame from the AP, the AP that receives the simultaneously transmitted CTS frames from the STAs cannot know which STAs responded with the CTS frames due to the simultaneous transmission. Due to multi-path, it is difficult for the AP to differentiate the received CTS frames by measuring the power difference across 20 MHz subchannels. Thus, it is difficult for the AP to determine the availability of each 20 MHz subchannel at each STA based on the MU-RTS and CTS frame exchange.

In HE and EHT, a non-AP STA is able to determine the availability of each 20 MHz subchannel at the STA based on performing a per-20 MHz energy detection (ED)-based clear channel assessment (CCA) and report the availability of each 20 MHz subchannel at the STA to the AP by transmitting a bandwidth query report (BQR) to the AP. BQR information may be provided in one or more BQR control fields included in an aggregated control (A-control) field. The BQR control field may include an available channel bitmap field for carrying a bitmap indicating the available subchannels, with each bit of the bitmap corresponding to a different 20 MHz subchannel. A HE STA may be allowed to transmit the BQR control field when the BQR support field included in the HE capabilities element indicates that BQR is supported. An EHT STA may be allowed to transmit two BQR control fields when the “two BQRs support” field included in the EHT capabilities element indicates that two BQRs are supported. When one BQR control field exists in an A-control field, the available channel bitmap field is applied to the operating channel bandwidth when the operating channel bandwidth is no more than 160 MHz. When one BQR control field exists in an A-control field, the available channel bitmap field is applied to the primary 160 MHz when the operating channel bandwidth is 320 MHz. When two BQR control fields exist in an A-control field, the available channel bitmap field included in the first BQR control field and the second BQR control field apply to the primary 160 MHz and the secondary 160 MHz of the operating channel bandwidth, respectively. Each bit in the bitmap carried by the available channel bitmap field corresponds to a 20 MHz subchannel within the operating channel bandwidth of the BSS with which the STA is associated, with the LSB (least significant bit) corresponding to the lowest numbered 20 MHz subchannel of the BSS. The bit in position X of the bitmap is set to binary ‘1’ to indicate that subchannel X+1 is idle; otherwise, the bit is set to binary ‘0’ to indicate that the subchannel is busy or unavailable. The bit width of the available channel bitmap field is eight bits to represent eight 20 MHz subchannels per BQR control field.

Relay communication can increase the flexibility of wireless network deployments. The use of relay communication has been considered for use in next generation wireless networks (e.g., in the upcoming IEEE 802.11bn wireless networking standard (Ultra High Reliability (“UHR”))) to improve rate-vs-range performance. For example, a STA/AP that cannot receive signals from an AP/STA can communicate with the AP/STA via relay communication. Also, relay communication may help improve the signal-to-noise (SNR) ration of a STA/AP with a low SNR. Two types of relay STAs have been considered for UHR. The first type of relay STA (type 1 relay STA) is a relay STA that has full AP functionality or soft-AP functionality. The second type of relay STA (type 2 relay STA) is a relay STA that does not have AP functionality, so the AP needs to control this type of relay STA. With a type 2 relay STA, the relay STA may not have the functionality of allocating DL/UL MU resources, similar to a normal STA. Thus, for MU operations via such relay STA, the AP needs to control the relay STA including providing information to the relay STA regarding the RUs allocated for the dSTAs, assuming the dSTAs are able to communicate with the AP via the relay STA. If the AP knows the availability of each 20 MHz subchannel at each dSTA, it can assist the AP with appropriately allocating DL/UL MU resources for dSTAs. Based on the current BQR framework specified in HE and EHT, the AP can only know the availability of each 20 MHz subchannel at the relay STA, but has no visibility regarding the availability of each 20 MHz subchannel at the dSTAs.

Various multi-AP coordination technologies have been considered for use in UHR including coordinated time division multiple access (CTDMA), coordinated orthogonal frequency division multiple access (COFDMA), joint transmission (JT), coordinated beamforming (CBF), co-UL-MU-MIMO, coordinated spatial reuse (CSR) and so on. To optimize resource utilization between a sharing AP and shared APs, the use of BQR and buffer status report (BSR) exchanges has been discussed. TXOP sharing in certain 20 MHz subchannels has been considered in CTDMA, COFDMA, and so on. If the availability of each 20 MHz subchannel at the shared AP and that of the STAs associated with the shared AP are not aligned, there is a chance that the shared AP cannot fully schedule transmissions for its STAs during the shared TXOP. Also, the resource utilization at the sharing AP and the shared APs during the shared TXOP may not be optimized. For example, consider the following scenario. The available channel bitmap field included in the BQR control field transmitted by the shared AP carries a value of “11011111” (referred to as the BQR of the shared AP) (this bitmap indicates that channels 1, 2, 4, 5, 6, 7, and 8 are idle), the available channel bitmap field included in the BQR control field transmitted by STA1 carries a value of “10110011” (referred to as the BQR of STA1) (this bitmap indicates that channels 1, 3, 4, 7, and 8 are idle), the available channel bitmap field included in the BQR control field transmitted by STA2 carries a value of “10110010” (referred to as the BQR of STA2) (the bitmap indicates that channels 1, 3, 4, and 7 are idle), the shared AP is ready to schedule transmissions for STA1 and STA2 during the shared TXOP based on their buffer status, and the operating channel bandwidth is 160 MHz.

In the above-described scenario, the sharing AP only knows the BQR of the shared AP, so it may decide to share its TXOP in subchannels 1, 2, 5, and 6 based on its knowledge of the BQR of the shared AP and assuming that the estimated number of subchannels that are to be used during the shared TXOP is four. However, since subchannels 2, 5, and 6 are not available or are busy at STA1 and STA2, the actual number of subchannels that can be used during the shared TXOP is only one. Thus, in this scenario, the shared AP cannot fully schedule transmissions for STA1 and STA2 during shared TXOP, and subchannels 2, 5, and 6 are wasted.

As mentioned above, the existing BQR mechanism has at least the following drawbacks. First, in a relay system, the AP cannot know the availability of each subchannel at each dSTA, making it difficult for the AP to appropriately allocate DL/UL MU resources for the dSTAs. Second, in a multi-AP system, the sharing AP cannot know the availability of each subchannel at the STAs that are associated with the shared AP, making it difficult for the sharing AP to appropriately allocate TXOP resources for the shared AP.

If a relay STA forwards the BQR of each dSTA to the AP, it can assist the AP in appropriately allocating DL/UL MU resources for the dSTAs. Also, if a shared AP forwards the BQR of its associated STAs to the sharing AP, it can assist the sharing AP in appropriately allocating TXOP resources.

The present disclosure describes formats and protocols for a relay STA in a relay system to report the availability of each subchannel at each dSTA to the AP and for a shared AP in a multi-AP system to report the availability of each subchannel at each STA that is associated with the shared AP to the sharing AP.

It is noted that in a relay system with a type 1 relay STA, the relay STA can be considered as being a shared AP and the dSTAs can be considered as STAs that are associated with the relay STA.

While various embodiments are described herein in the context of providing coordinated subchannel availability information (where BQR information is considered as being one type of subchannel availability information), it should be appreciated that embodiments can be used to provide other types of coordinated frequency resource availability information in a similar manner such as coordinated maximum available bandwidth information and coordinated punctured channel information. That is, coordinated BQR (CBQR) information is just one example of coordinated frequency resource availability information. Subchannel availability information may include the traditional BQR information and/or scheduling information for subchannels based on non-primary channel access (NPCA), dynamic subband operation (DSO), other transmission technologies (e.g., Bluetooth), power save, or any other technology that can affect availability of subchannels.

In a multi-AP system, the frequency resources (e.g., available maximum bandwidth, available subchannels, punctured channels, etc.) available at a shared AP and its associated STAs can change over time. If the sharing AP does not have accurate information regarding the frequency resource availability at the shared AP and its associated STAs, the sharing AP may not be able to allocate resources for an upcoming shared TXOP in a manner that optimizes network throughput. There can be several reasons why the frequency resource availability at a shared AP can change over time. For example, the available maximum bandwidth and/or available 20 MHz subchannels may change due to power save mode and/or due to resource usage from other technologies in coexistence (e.g., Bluetooth) at a shared AP and/or its associated STAs that have DL/UL buffer. As another example, the available 20 MHz subchannels at the shared AP and/or its associated STAs may change due to non-primary channel access (NPCA) operation and/or dynamic subchannel operation (DSO) of the shared AP. Also, the BQR information and/or punctured channel information at a shared AP and/or its associated STAs can change for various reasons.

Similarly, in a relay system, the frequency resources available at a relay STA and dSTAs can change over time. If the AP does not have accurate information regarding the frequency resource availability at the relay STA and dSTAs, the AP may not be able to allocate resources in a manner that optimizes rate-vs-range performance.

Embodiments allow for dynamically providing coordinated frequency resource availability information to allow for more efficient allocation of frequency resources. For example, a STA (e.g., a relay STA or a shared AP) may provide frequency resource availability information at another STA (e.g., dSTA or STA that is associated with the shared AP) to yet another STA (e.g., an associated AP of the relay STA or a sharing AP). The coordinated frequency resource availability information may be provided in existing fields or new to-be-determined (TBD) fields of a frame. In some embodiments, multiple types of coordinated frequency resource availability information can be provided together (e.g., in the same frame).

### Explicit CBQR

In an embodiment, a STA/AP (e.g., a relay STA or a shared AP) can provide information regarding the availability of each Z MHz subchannel at another STA (e.g., a dSTA or a STA that is associated with the shared AP) to yet another STA (e.g., an AP associated with the relay or a sharing AP). Such information may be referred to herein as coordinated BQR (CBQR) information. Support for CBQR can be indicated by an AP to a STA that can transmit CBQR. Z is the subchannel size and can be equal or larger than 20. For example, in the legacy sub-7 GHz band, Z can be 20, while in a mmWave band, Z can be equal or larger than 20.

Various ways to provide CBQR information are now described.

### Alt 1

In an embodiment (referred to herein as Alt 1), CBQR information is provided in an A-control field. The A-control field may include a CBQR control field that is used for carrying CBQR information. In an embodiment, the CBQR information is encoded as an 8-bit bitmap, with each bit in the bitmap corresponding to a different subchannel.

### Alt 1-1

In an embodiment (referred to herein as Alt 1-1), the bit in position X in the bitmap may be set to binary ‘1’ to indicate that subchannel X+1 is idle at both the STA that transmits the CBQR (referred to as the transmitting STA) and all other STAs that transmit BQRs to the transmitting STA; otherwise, it can be set to binary ‘0’ to indicate that the subchannel is busy or unavailable. The transmitting STA may obtain information regarding whether subchannel X+1 is idle or not at the other STAs based on the BQRs transmitted by the other STAs or from the corresponding subchannel(s) in the RU allocation field included in the trigger frame transmitted to the other STAs when the recipient of the trigger frame does not respond to the trigger frame (e.g., if an AP transmits a trigger frame to a first STA (STA1) and a second STA (STA2) with a RU allocation field for STA1 indicating that STA1 is assigned to subchannels 1 and 2 and a RU allocation field for a second STA2 indicating that STA2 is assigned to subchannels 3 and, but the AP only receives a response (a trigger-based PPDU) from STA1, the AP can know that subchannels 1 and 2 are available). For example, in a relay system, if subchannel X+1 is idle at the relay STA and all other dSTAs, the bit in position X in the bitmap in the CBQR can be set to binary ‘1’; otherwise, it can be set to binary ‘0’. As another example, in a multi-AP system, if subchannel X+1 is idle at the shared AP and all other STAs associated with the shared AP, the bit in position X in the bitmap in the CBQR can be set to binary ‘1’; otherwise, it can be set to binary ‘0’.

### Alt 1-2

In an embodiment (referred to herein as Alt 1-2), the bit in position X in the bitmap can be set to binary ‘1’ to indicate that subchannel X+1 is idle at all other STAs that transmit BQRs to the STA that transmits the CBQR (referred to as the transmitting STA); otherwise, it can be set to binary ‘0’ to indicate that the subchannel is busy or unavailable. The transmitting STA may obtain information regarding whether subchannel X+1 is idle or not at the other STAs based on the BQRs transmitted by the other STAs or from the corresponding subchannel(s) in the RU allocation field included in the trigger frame transmitted to the other STAs when the recipient of the trigger frame does not respond to the trigger frame (e.g., as described above for Alt 1-1). Information regarding whether subchannel X+1 is idle or not at the transmitting STA itself may be provided in the legacy BQR (e.g., as specified in HE or EHT). For example, in a relay system, if subchannel X+1 is idle at all dSTAs, the bit in position X in the bitmap in the CBQR can be set to binary ‘1’; otherwise, it can be set to binary ‘0’. As another example, in a multi-AP system, if subchannel X+1 is idle at all STAs associated with the shared AP, the bit in position X in the bitmap in the CBQR can be set to binary ‘1’; otherwise, it can be set to binary ‘0’.

The operating channel bandwidth may be the same among the transmitting STA and the other STAs that transmit BQRs to the transmitting STA. When one CBQR control field exists in an A-control field, the bitmap carried by the CBQR control field may apply to the operating channel bandwidth when the operating channel bandwidth is no more than Z*8 MHz, where Z is a subchannel size. When one CBQR control field exists in an A-control field, the bitmap carried by the CBQR control field may apply to the primary Z*8 MHz when the operating channel bandwidth is Z*16 MHz. When two CBQR control fields exist in an A-control field, the bitmaps carried by the first and second CBQR control fields may apply to the primary Z*8 MHz and the secondary Z*8 MHz, respectively. Each bit in a bitmap may correspond to a different Z MHz subchannel within the operating channel bandwidth of the BSS to which the transmitting STA belongs, with the LSB corresponding to the lowest numbered operating subchannel of the BSS.

### Alt 2

In an embodiment (referred to herein as Alt 2), CBQR information is provided in one or more CBQR control fields included in an A-control field. The CBQR control field may include L bits of the bitmap and K bits of information identifying the corresponding STA to which the bitmap applies. The STA that transmits the CBQR (referred to as the transmitting STA) may obtain the bitmap for a corresponding STA from the available channel bitmap field included in a BQR transmitted by the corresponding STA. The information identifying the corresponding STA may be the address of the corresponding STA or other type of identifier (e.g., AID12, transmitter address (TA), STA ID, etc.). The bitmap and the identifying information for a STA that has not transmitted a BQR can be omitted or the bitmap can be set to all zeros. In an embodiment, L+K+4 should be lesser or equal to the bit width of the A-control field. If the TA of the MPDU that includes the CBQR control field is set to the address of the corresponding STA, K can be 0.

The bit in position X in the bitmap carried in a CBQR control field for a corresponding STA may be set to binary ‘1’ to indicate that subchannel X+1 is idle at the corresponding STA; otherwise, it can be set to binary ‘0’ to indicate that the subchannel is busy or unavailable at the corresponding STA. For example, if subchannel X+1 is idle at the corresponding STA, the bit in position X in the bitmap carried by the CBQR control field for the corresponding STA may be set to binary ‘1’; otherwise, it may be set to binary ‘0’.

The operating channel bandwidth may be the same among the transmitting STA and the other STAs that transmit BQRs to the transmitting STA. L may be a fixed value. In an embodiment, L is 8 or 16.

### Alt 2-1: L is 8

In an embodiment when L is 8 and when one CBQR control field for a particular STA exists in the A-control field, the bitmap carried by the CBQR control field for the particular STA may apply to the operating channel bandwidth when the operating channel bandwidth is no more than Z*8 MHz. When one CBQR control field for a particular STA exists in the A-control field, the bitmap carried by the CBQR control field may apply to the primary Z*8 MHz when the operating channel width is Z*16 MHz. When two CBQR control fields for a particular STA exists in the A-control field, the bitmaps carried by the first and second CBQR control fields may apply to the primary Z*8 MHz and the secondary Z*8 MHz, respectively.

### Alt 2-2. L is 16

In an embodiment when L is 16, the bitmap carried by a CBQR control field applies to the operating channel bandwidth assuming the operating channel bandwidth is Z*16 MHz.

### Alt 2-3. L can be Another Value

In an embodiment, the bitmap carried by a CBQR control field applies to the operating channel bandwidth assuming the operating channel bandwidth is Z*L MHz. Each bit in the bitmap may correspond to a different Z MHz subchannel within the operating channel bandwidth of the BSS to which the transmitting STA belongs, with the LSB corresponding to the lowest numbered operating subchannel of the BSS.

### Alt 3

In an embodiment (referred to herein as Alt 3), CBQR information is provided in the frame body of a frame (instead of in the MAC header). The frame body may include M fields where each field includes L bits of the bitmap and K bits of information identifying the corresponding STA to which the bitmap applies. The format of each of the M fields may be the same or similar to the CBQR control field used in Alt 2 described above.

The above-mentioned Alt 1 is the simplest to implement, as it reuses the legacy BQR format. The above-mentioned Alt 1 has the lowest overhead among the above-mentioned Alts 1-3. The above-mentioned Alt 2 and Alt 3 can provide individual/separate BQR information for each STA, which allows for further optimization of resource allocation. The above-mentioned Alt 3 may require defining a new frame to provide CBQR information.

In an embodiment, the CBQR control field that is used in Alt 1 and Alt 2 mentioned above may use a different control ID from the control ID of the (legacy) BQR control field.

In an embodiment, the CBQR control field that is used in Alt 1 and Alt 2 mentioned above may use the same control ID as the (legacy) BQR control field. In this case, the following rule may be used to differentiate between the (legacy) BQR control field and the CBQR control field. If CBQR information is solicited, the field is a CBQR control field; otherwise, the field is a BQR control field.

Various protocols to obtain/provide CBQR information in a relay system and multi-AP system are now described for different scenarios.

Scenario 1-1: Protocols to Obtain/Provide CBQR Information in a Relay System when the Relay STA can Transmit or Forward Trigger Frames

In Scenario 1-1, one or more of following are assumed:

1) The relay STA or AP has indicated that it supports BQR or two BQRs to a dSTA and the dSTA can transmit a solicited BQR or an unsolicited BQR.

2) The AP has indicated that it supports CBQR to the relay STA and the relay STA can transmit a solicited CBQR or an unsolicited CBQR.

3) The relay STA can obtain BQR information from dSTAs in a solicited or unsolicited way.

4) The AP can allocate MU resources for dSTAs based on CBQR information.

5) HE, EHT, and future wireless networking standards (e.g., UHR) dSTAs can receive and decode a trigger frame transmitted by the relay STA. The relay STA may set the TA field of the trigger frame to the AP's TA.

6) The relay STA can receive and decode trigger-based PPDUs (TB PPDUs) transmitted by a dSTA. For example, the relay STA may decode a TB PPDU if it is transmitted by a dSTA corresponding to a user information field included in the trigger frame. As another example, the relay STA may decode the TB PPDU if the RA field includes the address of the AP.

### Option 1: AP Triggers BQRP and Solicits CBQR

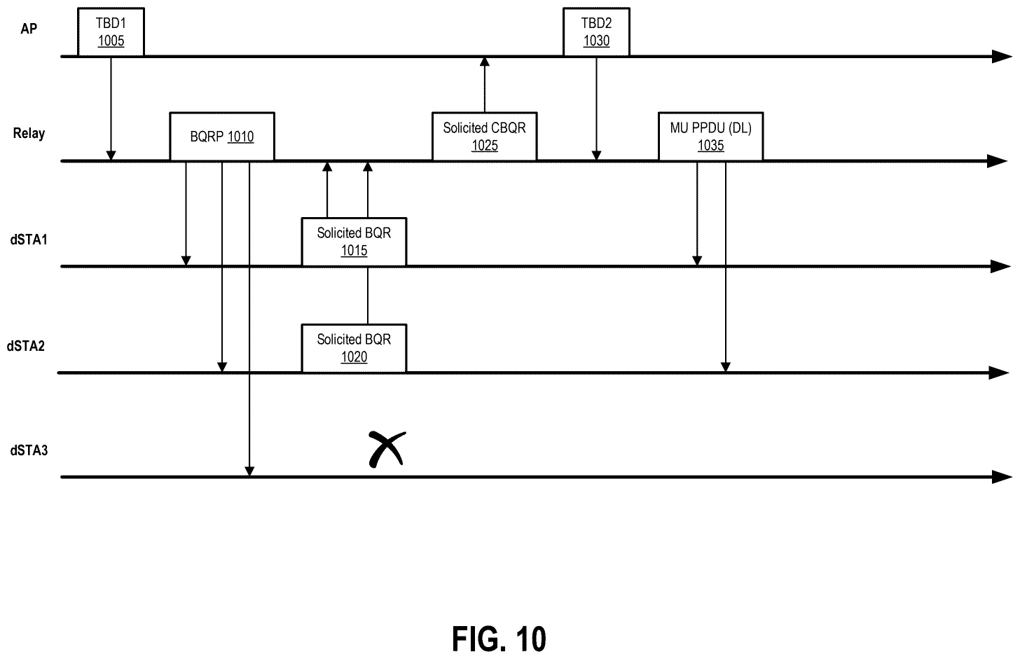

FIG. 10 is a diagram showing a communication sequence in a relay system when an AP triggers BQRP and solicits CBQR information for DL MU transmission via a relay STA when the relay STA can transmit trigger frames, according to some embodiments.

As shown in the diagram, the AP may transmit a frame (referred to as TBD1 frame 1005) to the relay STA. The TBD1 frame 1005 may include information for triggering the relay STA to transmit a BQRP frame 1010, information for soliciting a CBQR frame 1025 from the relay STA, and/or information for encoding the BQRP frame 1010.

For example, the information for encoding the BQRP frame 1010 may include information that is to be included in the user information fields of the BQRP frame 1010 such as RU allocation information, AID12 information, and/or other information that is to be included in other fields included in the user information field.

In an embodiment, the information for encoding trigger frames (e.g., BQRP frame, MU-RTS frame, basic trigger frame, etc.) can be indicated before the TBD1 frame 1005 is transmitted.

In response to receiving the TBD1 frame 1005, the relay STA may transmit the BQRP frame 1010 to destination STAs (dSTA1, dSTA2, and dSTA3) to solicit BQR information from the destination STAs. In an embodiment, a MU-RTS frame and CTS frame can be exchanged between the relay STA and the dSTAs before transmission of the BQRP frame 1010. In response to receiving the BQRP frame 1010, dSTA1 and dSTA2 may transmit solicited BQR frame 1015 and solicited BQR frame 1020, respectively, to the relay STA. In this example, dSTA3 does not respond to the BQRP frame 1010. The relay STA may then transmit a solicited CBQR frame 1025 to the AP. The solicited CBQR frame 1025 may include CBQR information for dSTA1 and dSTA2 that is generated based on the BQR information included in solicited BQR frame 1015 and solicited BQR frame 1020 received from dSTA1 and dSTA2, respectively, and/or generated based on the subchannel(s) associated in the RU allocation subfields in the User Info field that is addressed dSTA3 in the BQRP frame 1010. The AP may allocate MU resources for a downlink and/or uplink transmission based on the CBQR information included in the solicited CBQR frame 1025 received from the relay STA. The AP may then transmit a frame (referred to as TBD2 frame 1030) to the relay STA. For a DL MU transmission, the TBD2 frame 1030 may include information for encoding the SIG (signal) field in the DL MU PPDU 1035 that is to be transmitted by the relay STA (e.g., RU allocation information, user information, etc.) and/or the data to be included in the DL MU PPDU 1035 that is to be transmitted by the relay STA. For a UL MU transmission, the TBD2 frame 1030 may include information for encoding trigger frames (e.g., MU-RTS frame, basic trigger frame, etc.) that are to be transmitted by the relay STA for soliciting the uplink MU transmission.

In this example, the TBD2 frame 1030 is for a DL MU transmission so in response to receiving the TBD2 frame 1030, the relay STA transmits a DL MU PPDU 1035 to dSTA1 and dSTA2 using information obtained from the TBD2 frame 1030.

### Option 2: AP Solicits CBQR

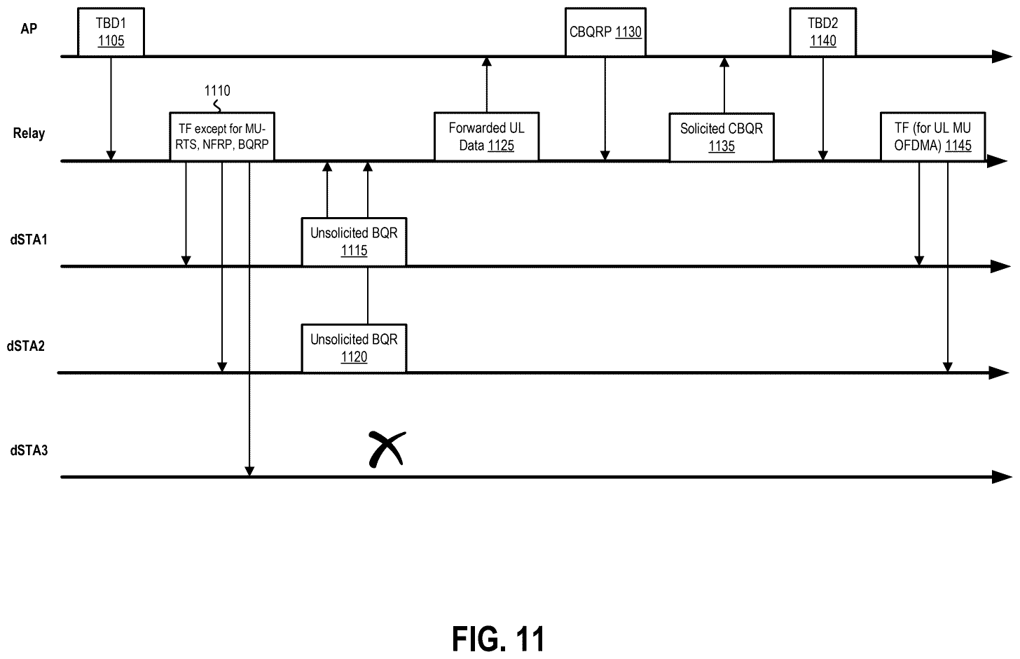

FIG. 11 is a diagram showing a communication sequence in a relay system when an AP solicits CBQR information for UL MU transmission via a relay STA when the relay STA can transmit trigger frames, according to some embodiments.

As shown in the diagram, the AP may transmit a frame (referred to as TBD1 frame 1105) to the relay STA. The TBD1 frame 1005 may include information for encoding the trigger frame 1110 that is to be transmitted by the relay STA. For example, the information for encoding the trigger frame 1110 may include information to be included in the user information fields of the trigger frame 1110 such as RU allocation, AID12, and/or other information that is to be included in other fields included in the user information fields.

In response to receiving the TBD1 frame 1105, the relay STA may transmit the trigger frame 1110 to the destination STAs (dSTA1, dSTA2, and dSTA3). In an embodiment, a MU-RTS frame and CTS frame can be exchanged between the relay STA and the dSTAs before transmission of the trigger frame 1110. If the trigger frame 1110 is a BQRP frame, the dSTAs may transmit solicited BQR frames to the relay STA. If the trigger frame 1110 is not a BQRP frame, MU-RTS frame, or NFRP frame, the dSTAs may transmit unsolicited BQR frames to the relay STA. In this example, it is assumed that the trigger frame 1110 is not a BQRP frame, a MU-RTS frame, or a NFRP frame. As such, dSTA1 and dSTA2 may transmit unsolicited BQR frame 1115 and unsolicited BQR frame 1120, respectively, to the relay STA. In this example, dSTA3 does not respond to the trigger frame 1110. The relay STA may then transmit frame 1125 to the AP to forward data received from dSTA1 and dSTA2 except the BQR information received from the dSTAs.

The AP may transmit the CBQRP frame 1130 to the relay STA to solicit CBQR information from the relay STA. In response to receiving the CBQRP frame 1130, the relay STA may transmit a solicited CBQR frame 1135 to the AP that includes the latest CBQR information. The latest CBQR information may be generated based on the BQR information included in the latest solicited or unsolicited BQR frames received from the dSTAs. In this example, the latest CBQR information is generated based on unsolicited BQR frames received from dSTA1 and dSTA2 and/or based on the subchannel(s) associated in the RU allocation fields in the user information field that is addressed to dSTA3 in the trigger frame. The AP may allocate MU resources for a downlink and/or uplink transmission based on the CBQR information included in the solicited CBQR frame 1135 received from the relay STA. The AP may then transmit a frame (referred to as TBD2 frame 1140) to the relay STA. For a DL MU transmission, the TBD2 frame 1140 may include information for encoding the SIG field in the DL MU PPDU that is to be transmitted by the relay STA (e.g., RU allocation information, user information, etc.) and/or the data to be included in the DL MU PPDU that is to be transmitted by the relay STA. For a UL MU transmission, the TBD2 frame 1140 may include information for encoding trigger frames (e.g., MU-RTS frame, basic trigger frame, etc.) that are to be transmitted by the relay STA for soliciting the uplink MU transmission such as trigger frame 1145.

In this example, the TBD2 frame 1140 is for an UL MU transmission so in response to receiving the TBD2 frame 1140, the relay STA may transmit the trigger frame 1145 to solicit uplink transmissions from dSTA1 and dSTA2 using information obtained from the TBD2 frame 1140.

### Option 3: CBQR is Unsolicited

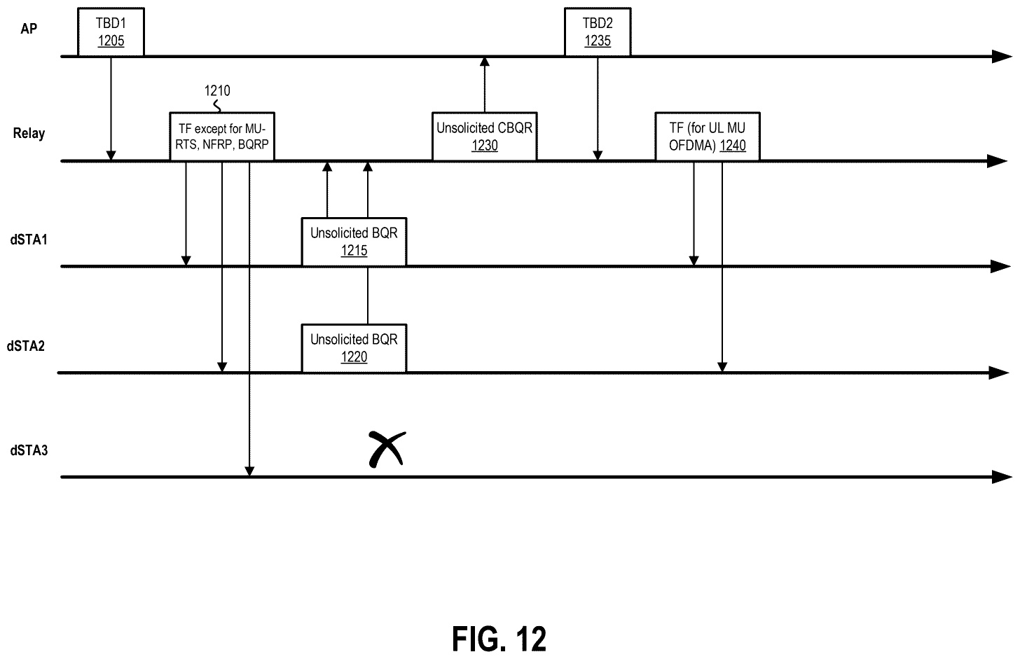

FIG. 12 is a diagram showing a communication sequence in a relay system when CBQR is unsolicited for UL MU transmission via a relay STA when the relay STA can transmit trigger frames, according to some embodiments.

As shown in the diagram, the AP may transmit a frame (referred to as TBD1 frame 1205) to the relay STA. The TBD1 frame 1205 may include information for encoding the trigger frame 1210 that is to be transmitted by the relay STA. For example, the information for encoding the trigger frame 1210 may include information to be included in the user information fields of the trigger frame 1110 such as RU allocation, AID12, and/or other information that is to be included in other fields included in the user information field.

In response to receiving the TBD1 frame 1205, the relay STA may transmit the trigger frame 1210 to the destination STAs (dSTA1, dSTA2, and dSTA3). In an embodiment, a MU-RTS frame and CTS frame can be exchanged between the relay STA and the dSTAs before transmission of the trigger frame 1210. If the trigger frame 1210 is a BQRP frame, dSTA1 and dSTA2 may transmit solicited BQR frames to the relay STA. If the trigger frame 1210 is not a BQRP frame, MU-RTS frame, or NFRP frame, the dSTAs may transmit unsolicited BQR frames to the relay STA. In this example, it is assumed that the trigger frame 1210 is not a BQRP frame, a MU-RTS frame, or a NFRP frame. As such, dSTA1 and dSTA2 may transmit unsolicited BQR frame 1215 and unsolicited BQR frame 1220, respectively, to the relay STA.

In this example, dSTA3 does not respond to the trigger frame 1210.

The relay STA may then transmit an unsolicited CBQR frame 1230 to the AP, if possible. The CBQR frame 1230 may include CBQR information that was generated based on the latest solicited or unsolicited BQR frames received from the dSTAs. In this example, the latest CBQR information is generated based on unsolicited BQR frames received from dSTA1 and dSTA2 and/or based on the subchannel(s) associated in the RU allocation fields in the user information field that is addressed to dSTA3 in the trigger frame. The AP may allocate MU resources for a downlink and/or uplink transmission based on the CBQR information included in the unsolicited CBQR frame 1230 received from the relay STA. The AP may then transmit a frame (referred to as TBD2 frame 1235) to the relay STA. For a DL MU transmission, the TBD2 frame 1235 may include information for encoding the SIG field in the DL MU PPDU that is to be transmitted by the relay STA (e.g., RU allocation information, user information, etc.) and/or the data to be included in the DL MU PPDU that is to be transmitted by the relay STA. For a UL MU transmission, the TBD2 frame 1235 may include information for encoding trigger frames (e.g., MU-RTS frame, basic trigger frame, etc.) that are to be transmitted by the relay STA such as trigger frame 1240.

In this example, the TBD2 frame 1235 is for an UL MU transmission so in response to receiving the TBD2 frame 1235, the relay STA may transmit the trigger frame 1240 to solicit uplink transmissions from dSTA1 and dSTA2 using information obtained from the TBD2 frame 1235.

Scenario 1-2: Protocols to Obtain/Provide CBQR Information in a Relay System when the Relay STA does not Transmit Trigger Frames

In Scenario 1-2, one or more of following are assumed:
1) The AP may not be able to decode signals transmitted by dSTAs.
2) The dSTAs can decode signals transmitted by the AP.
3) The AP has indicated that it supports BQR or two BQRs to a dSTA and the dSTA can transmit a solicited BQR or an unsolicited BQR.
4) The AP has indicated that it supports CBQR to the relay STA and the relay STA can transmit a solicited CBQR or an unsolicited CBQR.
5) The relay STA can obtain BQR information from dSTAs in a solicited or unsolicited way.
6) The AP can allocate MU resources for dSTAs based on CBQR information.
7) The relay STA can receive and decode trigger-based PPDUs (TB PPDUs) transmitted by a dSTA. For example, the relay STA may decode a TB PPDU if it is transmitted by a dSTA corresponding to a user information field included in the trigger frame. As another example, the relay STA may decode the TB PPDU if the RA field includes the address of the AP.

### Option 1: AP Triggers BQRP and Solicits CBQR

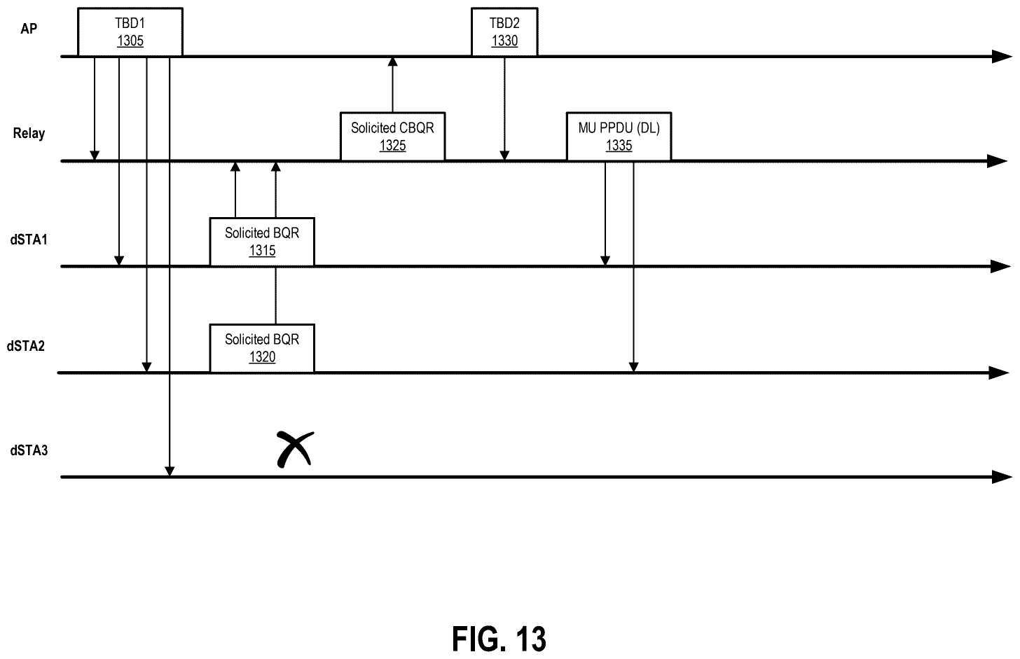

FIG. 13 is a diagram showing a communication sequence in a relay system when an AP triggers BQRP and solicits CBQR information for DL MU transmission via a relay STA when the relay STA does not transmit trigger frames, according to some embodiments.

As shown in the diagram, the AP may transmit a frame (referred to as TBD1 frame 1305) to the relay STA and the dSTAs (dSTA1, dSTA2, and dSTA3). The TBD1 frame 1305 may include information for soliciting BQR information from the dSTAs. The dSTAs may be a HE, EHT, or future wireless networking standard (e.g., UHR) STA. The TBD1 frame 1305 may be a variant of a BQRP frame or other type of trigger frame. The TBD1 frame 1305 may also include information for soliciting CBQR information from the relay STA. In an embodiment, a MU-RTS frame and CTS frame can be exchanged between the AP, the relay STA, and the dSTAs before transmission of the TBD1 frame 1305.

In response to receiving the TBD1 frame 1305, dSTA1 and dSTA2 may transmit solicited BQR frame 1315 and solicited BQR frame 1320, respectively, to the relay STA. In this example, dSTA3 does not respond to the TBD1 frame 1305. The relay STA may then transmit a solicited CBQR frame 1325 to the AP. The solicited CBQR frame 1325 may include CBQR information for dSTA1 and dSTA2 that is generated based on the BQR information included in solicited BQR frame 1315 and solicited BQR frame 1320 received from dSTA1 and dSTA2, respectively, and/or generated based on the subchannel(s) associated in the RU allocation fields in the user information field that is addressed to dSTA3 in the TBD1 frame 1305.

The AP may allocate MU resources for a downlink and/or uplink transmission based on the CBQR information included in the solicited CBQR frame 1325 received from the relay STA. The AP may then transmit a frame (referred to as TBD2 frame 1330) to the relay STA. For a DL MU transmission, the TBD2 frame 1330 may include information for encoding the SIG field in the DL MU PPDU 1335 that is to be transmitted by the relay STA (e.g., RU allocation information, user information, etc.), the data to be included in the DL MU PPDU 1335 that is to be transmitted by the relay STA, and/or a DL MU PPDU that can be received by the dSTAs. For a UL MU transmission, the TBD2 frame 1330 may include trigger frames (e.g., MU-RTS frame, basic trigger frame, etc.) that can be received by the dSTAs and the relay STA.

In this example, the TBD2 frame 1330 is for a DL MU transmission so in response to receiving the TBD2 frame 1330, the relay STA may transmit a DL MU PPDU 1335 to dSTA1 and dSTA2 using information obtained from the TBD2 frame 1330.

### Option 2: AP Solicits CBQR

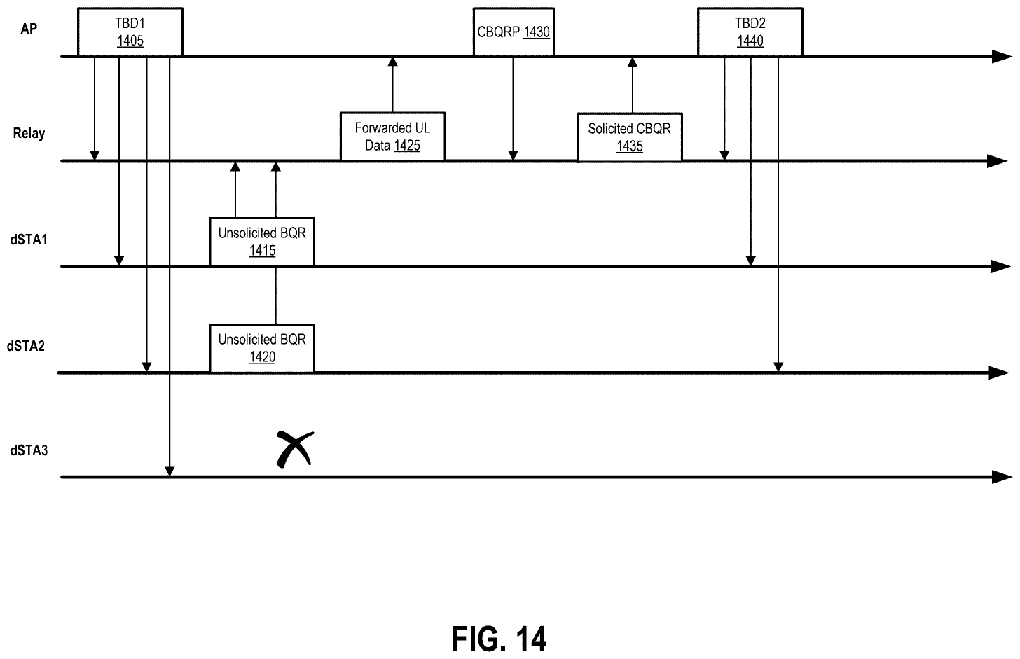

FIG. 14 is a diagram showing a communication sequence in a relay system when an AP solicits CBQR for UL MU transmission via a relay STA when the relay STA does not transmit trigger frames, according to some embodiments.

As shown in the diagram, the AP may transmit a frame (referred to as TBD1 frame 1405) to the relay STA and the dSTAs (dSTA1, dSTA2, and dSTA3). The TBD1 frame 1405 may include information for triggering uplink transmission by the dSTAs. The TBD1 frame 1405 may be a variant of a trigger frame (e.g., a variant of a HE trigger frame or EHT trigger frame). The TBD1 frame 1405 may also include information for triggering the relay STA to forward uplink data to the AP. In an embodiment, a MU-RTS frame and CTS frame can be exchanged between the AP, the relay STA, and the dSTAs before transmission of the TBD1 frame 1405.

In response to receiving the TBD1 frame 1405, if the TBD1 frame 1405 is a BQRP frame (or a variant thereof), the dSTAs may transmit solicited BQR frames to the relay STA. If the TBD1 frame 1405 is not a BQRP frame, a MU-RTS frame, or a NFRP frame (or a variant thereof), dSTA1 and dSTA2 may transmit unsolicited BQR frames to the relay STA. In this example, it is assumed that the TBD1 frame 1405 is not a BQRP frame, a MU-RTS frame, or a NFRP frame. As such, dSTA1 and dSTA2 may transmit unsolicited BQR frame 1415 and unsolicited BQR frame 1420, respectively, to the relay STA. In this example, dSTA3 does not respond to the TBD1 frame 1405. The relay STA may then transmit frame 1425 to the AP to forward data received from dSTA1 and dSTA2 except the BQR information received from the dSTAs.

The AP may transmit the CBQRP frame 1430 to the relay STA to solicit CBQR information from the relay STA. In response to receiving the CBQRP frame 1430, the relay STA may transmit a solicited CBQR frame 1435 to the AP that includes the latest CBQR information. The latest CBQR information can be generated based on BQR information included in the latest solicited or unsolicited BQR frames received from the dSTAs. In this example, the latest CBQR information is generated based on unsolicited BQR frames received from dSTA1 and dSTA2 and/or based on the subchannel(s) associated in the RU allocation fields included in the user information field that is addressed to dSTA3 in the trigger frame. The AP may allocate MU resources for a downlink and/or uplink transmission based on the CBQR information included in the solicited CBQR frame 1435 received from the relay STA. The AP may then transmit a frame (referred to as TBD2 frame 1440) to the relay STA, dSTA1, and dSTA2. For a DL MU transmission, the TBD2 frame 1440 may include information for encoding the SIG field in the DL MU PPDU that is to be transmitted by the relay STA (e.g., RU allocation information, user information, etc.), the data to be included in the DL MU PPDU that is to be transmitted by the relay STA, and/or a DL MU PPDU that can be received by the dSTAs. For a UL MU transmission, the TBD2 frame 1440 may include trigger frames (e.g., MU-RTS frame, basic trigger frame, etc.) that can be received by the dSTAs and the relay STA.

In this example, the TBD2 frame 1440 is for an UL MU transmission so in response to receiving the TBD2 frame 1440, dSTA1 and dSTA2 may transmit uplink frames toward the AP and the relay STA may relay the uplink frames to the AP using information obtained from the TBD2 frame 1440.

### Option 3: CBQR is Unsolicited

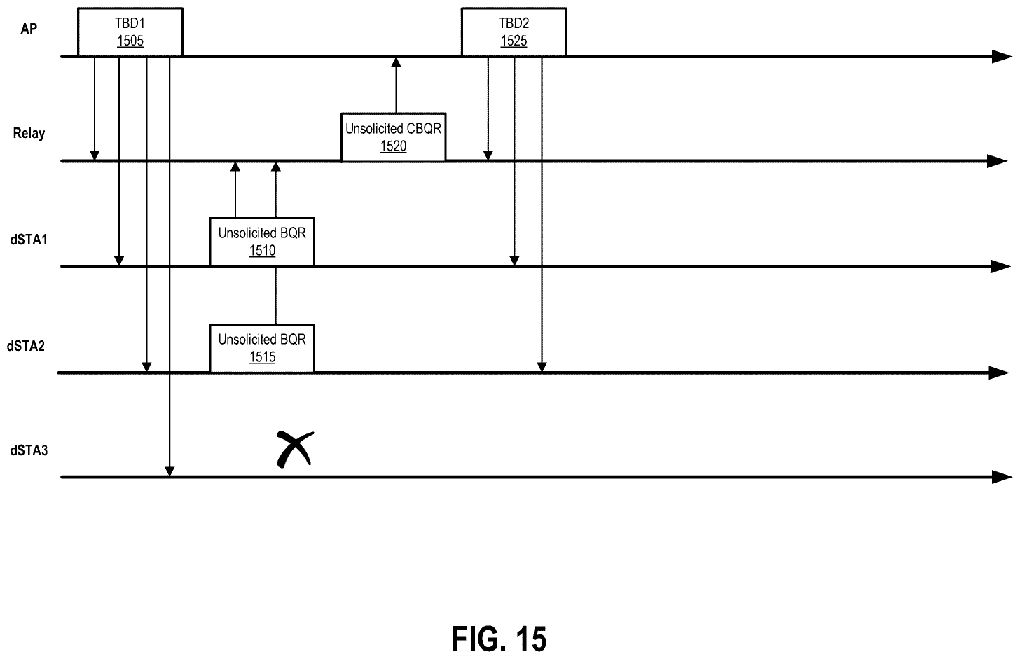

FIG. 15 is a diagram showing a communication sequence in a relay system when CBQR is unsolicited for UL MU transmission via a relay STA when the relay STA does not transmit trigger frames, according to some embodiments.

As shown in the diagram, the AP may transmit a frame (referred to as TBD1 frame 1505) to the relay STA and dSTAs (dSTA1, dSTA2, and dSTA3). The TBD1 frame 1505 may include information for triggering uplink transmission by dSTAs. The TBD1 frame 1505 may be a variant of a trigger frame (e.g., variant of a HE trigger frame or EHT trigger frame). The TBD1 frame 1505 may also include information for triggering the relay STA to forward uplink data to the AP. In an embodiment, a MU-RTS frame and CTS frame can be exchanged between the AP, the relay STA, and the dSTAs before transmission of the TBD1 frame 1505.

In response to receiving the TBD1 frame 1505, if the TBD1 frame 1505 is a BQRP frame (or a variant thereof), dSTA1 and dSTA2 may transmit solicited BQR frames to the relay STA. If the TBD1 frame 1505 is not a BQRP frame, a MU-RTS frame, or a NFRP frame (or a variant thereof), dSTA1 and dSTA2 may transmit unsolicited BQR frames to the relay STA. In this example, it is assumed that the TBD1 frame 1505 is not a BQRP frame, a MU-RTS frame, or a NFRP frame. As such, dSTA1 and dSTA2 may transmit unsolicited BQR frame 1510 and unsolicited BQR frame 1515, respectively, to the relay STA. In this example, dSTA3 does not respond to the TBD1 frame 1505. The relay STA may then transmit an unsolicited CBQR frame 1520 to the AP, if possible. The unsolicited CBQR frame 1520 may include CBQR information that was generated based on BQR information included in the latest solicited or unsolicited BQR frames received from the dSTAs. In this example, the latest CBQR information is generated based on unsolicited BQR frames received from dSTA1 and dSTA2 and/or based on the subchannel(s) associated in the RU allocation fields included in the user information field that is addressed to dSTA3 in the trigger frame. The AP may allocate MU resources for a downlink and/or uplink transmission based on the CBQR information included in the unsolicited CBQR frame 1520 received from the relay STA. The AP may then transmit a frame (referred to as TBD2 frame 1525) to the relay STA, dSTA1, and dSTA2. For a DL MU transmission, the TBD2 frame 1525 may include information for encoding the SIG field in a DL MU PPDU that is to be transmitted by the relay STA (e.g., RU allocation information, user information, etc.), the data to be included in the DL MU PPDU that is to be transmitted by the relay STA, and/or a DL MU PPDU that can be received by the dSTAs. For a UL MU transmission, the TBD2 frame 1525 may include trigger frames (e.g., MU-RTS frame, basic trigger frame, etc.) that can be received by the dSTAs and the relay STA.

In this example, the TBD2 frame 1525 is for an UL MU transmission so in response to receiving the TBD2 frame 1525, dSTA1 and dSTA2 may transmit uplink frames toward the AP and the relay STA may relay the uplink frames to the AP using information obtained from the TBD2 frame 1525.

### Scenario 2: Protocols to Obtain/Provide CBQR Information in a Multi-AP System

In Scenario 2, one or more of followings are assumed:
1) A multi-AP coordination setup procedure may have been completed before a sharing AP shares a TXOP with a shared AP.
2) The shared AP may obtain BQR information from its associated STAs in a solicited or unsolicited way.
3) The sharing AP has indicated that it supports CBQR to the shared AP and the shared AP can transmit a solicited CBQR or an unsolicited CBQR.
4) The sharing AP can determine the duration of the shared TXOP and the subchannel used in the shared TXOP based on the shared AP's resources. The shared AP's resource can include one or more of the followings: DL buffer status of the shared AP that would be transmitted during the shared TXOP, UL buffer status of the shared AP's scheduling STA that would be transmitted during the shared TXOP, available subchannels at the shared AP, and available subchannels at STAs associated with the shared AP that would be scheduled during the shared TXOP.

### Option 1: Sharing AP Triggers BQRP and Solicits CBQR

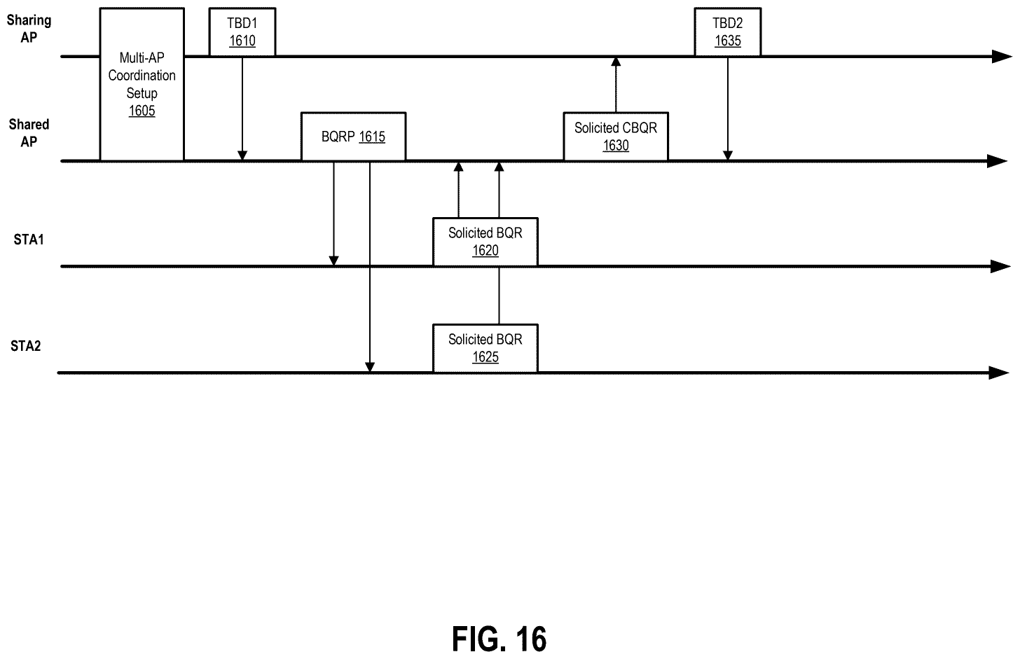

FIG. 16 is a diagram showing a communication sequence in a multi-AP system when a sharing AP triggers BQRP and solicits CBQR information, according to some embodiments.

As shown in the diagram, following completion of a multi-AP coordination setup procedure 1605, the sharing AP may transmit a frame (referred to as TBD1 frame 1610) to the shared AP. The TBD1 frame 1610 may include information for triggering the shared AP to transmit a BQRP frame 1615, information for soliciting a CBQR frame 1630 from the shared AP, and/or information regarding the time and frequency resources for the shared TXOP for BQRP, BQR, and/or CBQR exchanges. The sharing AP may determine the resources to allocate for the shared TXOP based on the reported resources of the shared AP, if it has been reported.

In response to receiving the TBD1 frame 1610, the shared AP may transmit the BQRP frame 1615 to its associated STAs (STA1 and STA2). In an embodiment, a MU-RTS frame and CTS frame can be exchanged between the shared AP and its associated STAs before transmission of the BQRP frame 1615. In response to receiving the BQRP frame 1615, STA1 and STA2 may transmit a solicited BQR frame 1620 and a solicited BQR frame 1625, respectively, to the shared AP. The relay STA may then transmit a solicited CBQR frame 1630 to the AP. The solicited CBQR frame 1630 may include CBQR information for STA1 and STA2 that is generated based on the BQR information included in solicited BQR frame 1620 and solicited BQR frame 1625 received from STA1 and STA2, respectively. The sharing AP may allocate resources for the shared TXOP based on the CBQR information included in the solicited CBQR frame 1630 received from the shared AP. The sharing AP may then transmit a frame (referred to as TBD2 frame 1635) to the shared AP. The TBD2 frame 1635 may include information regarding the resources allocated for the shared TXOP.

### Option 2: Sharing AP Solicits CBQR

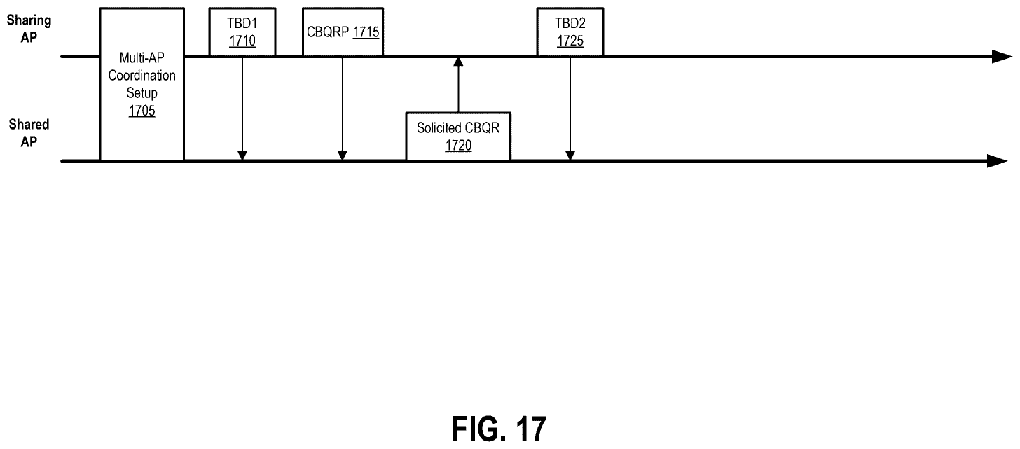

FIG. 17 is a diagram showing a communication sequence in a multi-AP system when a sharing AP solicits CBQR, according to some embodiments.

As shown in the diagram, following completion of a multi-AP coordination setup procedure 1705, the sharing AP may transmit a frame (referred to as TBD1 frame 1710) to the shared AP. In an embodiment, the TBD1 frame 1710 includes information regarding the time and frequency resources of a shared TXOP for data exchange between the shared AP and its associated STAs. The sharing AP may determine the resources to allocate for the shared TXOP based on the reported resources of the shared AP, if it has been reported.

The sharing AP may transmit a CBQRP frame 1715 to the shared AP to solicit CBQR information from the shared AP. In an embodiment, a MU-RTS frame and CTS frame can be exchanged between the shared AP and its associated STAs before transmission of the CBQRP frame 1715 (e.g., to protect the link between them during a TXOP shared by the sharing AP with the shared AP using the TBD1 frame 1710). In response to receiving the CBQRP frame 1715, the shared AP may transmit a solicited CBQR frame 1720 to the sharing AP that includes the latest CBQR information. The latest CBQR information can be generated based on the BQR information included in the latest solicited or unsolicited BQR frames received from the shared AP's associated STAs. The sharing AP may allocate resources for the shared TXOP based on the CBQR information included in the solicited CBQR frame 1720 received from the shared AP. The sharing AP may then transmit a frame (referred to as TBD2 frame 1725) to the relay STA that includes information regarding the resources allocated for the shared TXOP.

### Option 3: CBQR is Unsolicited

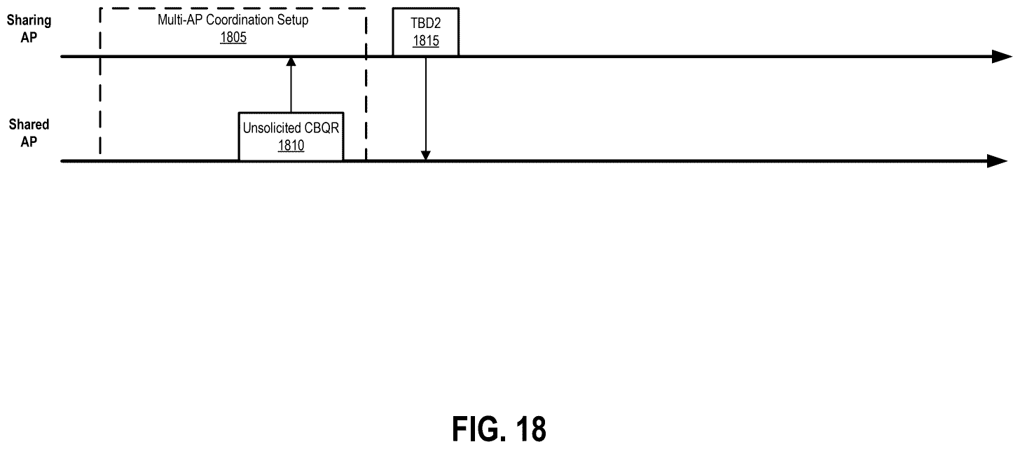

FIG. 18 is a diagram showing a communication sequence in a multi-AP system when CBQR is unsolicited, according to some embodiments.

As shown in the diagram, during a multi-AP coordination setup procedure 1805, the shared AP may transmit an unsolicited CBQR frame 1810 to the sharing AP, potentially together with QoS data, QoS null, and/or management frames. The unsolicited CBQR frame 1810 may include CBQR information. The CBQR information can be generated based on the BQR information included in the latest solicited or unsolicited BQR frames received from the shared AP's associated STAs. The sharing AP may allocate resources for the shared TXOP based on the CBQR information included in the unsolicited CBQR frame 1810 received from the shared AP. The sharing AP may then transmit a frame (referred to as TBD2 frame 1815) to the shared AP that includes information regarding the resources allocated for the shared TXOP.

### Implicit CBQR

In an embodiment, CBQR information can be implicitly obtained from channel protection information. For example, in a relay system, a relay STA may provide information regarding the protection of each Z MHz subchannel among the relay STA and the dSTAs to the associated AP. The associated AP may implicitly determine CBQR information based on the channel protection information. As another example, in a multi-AP system, a shared AP may provide information regarding the protection of each Z MHz subchannel among the shared AP and its associated STAs to the sharing AP. The sharing AP may implicitly determine CBQR information based on the channel protection information.

Various ways to provide the channel protection information for each Z MHz subchannel in various scenarios are now explained.

It is noted that although for the sake of simplicity embodiments are described herein that use a MU RTS/CTS exchange channel protection mechanism, it should be appreciated that other types of channel protection mechanisms (e.g., RTS/CTS exchange, BSRP/BSR (buffer status report poll and buffer status report) exchange or other type of frame exchange) can be used to implicitly determine CBQR information without departing from the spirit of the present disclosure. Also, it is noted that Z (subchannel size) can be equal to or larger than 20. For example, in the legacy sub-7 GHz band, Z can be 20, while in the mmWave band, Z can be equal to or larger than 20. Also, it is noted that the implicit CBQR information technique can be seen as providing implicit CBQR information by selecting the channel width of a forwarding frame.

Scenario 1-1: Implicit CBQR in a Relay System when the Relay STA can Transmit MU-RTS Trigger Frame

In Scenario 1-1, one or more of followings are assumed:
1) The relay STA can receive simultaneously transmitted CTS frames from the dSTAs and can determine which Z MHz subchannel is not protected.
2) HE, EHT, and future standards (e.g., UHR) dSTAs can receive and decode the MU-RTS trigger frame transmitted by the relay STA. The relay STA may set the TA field of the MU-RTS frame to the AP's TA.
3) The relay STA can transmit a TBD3 frame in certain subchannels. In an embodiment, the certain subchannels are determined based on the protected subchannels among the relay STA and dSTAs. In an embodiment, the certain subchannels are determined based on the receive power of CTS frames in each Z MHz subchannel.
4) In mm-Wave systems, a small number of users (e.g., two users) for MU transmission is considered due to small rank (e.g., in mm-Wave systems, small number of streams can be received at the receiver side due to higher directivity of beamforming).
5) In mm-Wave systems, a CTS frame may pass through a strong loss of signal (LoS) path (i.e., multi-path property is weak).
6) Z=20, but it should be appreciated that Z can have a different value.

Steps for implicitly determining CBQR information in a relay system when the relay STA can transmit a MU-RTS trigger frame are now described.
Step 1: The AP may indicate to the relay STA the user information field for MU-RTS transmission. In this example, it is assumed that the RU allocation fields included in the MU-RTS frame transmitted by the relay STA are set to P20 (primary 20 MHz channel) for STA1 and P40 (primary 40 MHz channel) for STA2.
Step 2a: STA1 may respond to the MU-RTS frame by transmitting a CTS frame in P20.
Step 3a. The relay STA may determine based on the CTS frame that P20 is protected but P40 is not protected.
Step 4a. The relay STA may transmit a frame (referred to as TBD3 frame) in P20.
Step 5a. The associated AP may determine based on the TBD3 frame being transmitted in P20 that P20 is protected among the relay STA, dSTA1, and dSTA2.
Step 6a. The associated AP may implicitly determine that the subchannels in P40 are not available at dSTA2.

An alternative embodiment may include the following steps (in lieu of the same-numbered steps above):
Step 2b: STA1 and STA2 may respond to the MU-RTS frame by transmitting CTS frames in P20 and P40, respectively, or STA2 transmits a CTS frame in P40.
Step 3b. The relay STA may determine that P40 is protected based on the CTS frame(s).
Step 4b. The relay STA may transmit a TBD3 frame in P40.
Step 5b. The associated AP may determine based on the TBD3 frame being transmitted in P40 that P40 is protected among the relay STA, dSTA1, and dSTA2.
Step 6b. The associated AP may implicitly determine that at least the subchannels in P40 are available at dSTA2.

Another alternative embodiment may include the following steps (in lieu of the same numbered steps above). This embodiment may be particularly applicable in a mmWave system.
Step 2c: STA1 and STA2 may respond to the MU-RTS frame by transmitting CTS frames in P20 and P40, respectively.
Step 3c. The relay STA may determine that both P20 at STA1 and P40 at STA2 are protected if the received power in P20 of the CTS frame minus the received power in P40 except for P20 (i.e., secondary 20 MHz channel (S20) in this example) of the CTS frame is higher than a given threshold.
Step 4c: The relay STA may transmit a TBD3 frame in P40 such that the transmit power in P20 is larger than the transmit power in S20.
Step 5c: The associated AP may determine that both P20 at STA1 and P40 at STA2 are protected if the receive power in P20 of the TBD3 frame minus the receive power in P40 except for P20 (i.e., S20 in this example) of the TBD3 frame is higher than a given threshold.
Step 6c: The associated AP may implicitly determine that the subchannels in P20 are available at dSTA1 and the subchannels in P40 are available at dSTA2 based on the determination that both P20 at STA1 and P40 at STA2 are protected.

It is noted that the given threshold can be a predefined value, a value indicated/provided by the AP, a value reported by the relay STA, or a value calculated from a previous sounding protocol. Also, it is noted that the given threshold that is used at the relay STA and the AP can be different.

Another alternative embodiment may include the following steps (in lieu of the same numbered steps above). This embodiment may be particularly applicable in a mmWave system.
Step 2d: STA2 may respond to the MU-RTS frame by transmitting a CTS frame in P40.
Step 3d: The relay STA may determine that P40 at STA2 is protected if the receive power in P20 of the CTS frame minus the receive power in P40 except for P20 (i.e., S20 in this example) of the CTS frame is lower than a given threshold.
Step 4d: The relay STA may transmit TBD3 frame in P40 such that the transmit power in P20 is the same as the transmit power in S20.
Step 5d: The associated AP may determine that P40 at STA2 is protected if the receive power in P20 of the TBD3 frame minus the receive power in P40 except for P20 (i.e., S20 in this example) of the TBD3 frame is lower than a given threshold.
Step 6d: The associated AP may implicitly determine that the subchannels in P40 are available at dSTA2 based on the determination that P40 at STA2 is protected.

It is noted that the given threshold can be a predefined value, a value indicated/provided by the AP, a value reported by the relay STA, or a value calculated from a previous sounding protocol. Also, it is noted that the given threshold that is used at the relay STA and the AP can be different.

Scenario 1-2: Implicit CBQR in a Relay System when the Relay STA does not Transmit MU-RTS Trigger Frame

In Scenario 1-2, one or more of the following are assumed.
1) The AP may not be able to decode signals transmitted by dSTAs.
2) The dSTAs can decode signals transmitted by the AP.
3) The relay STA can receive simultaneous CTS frames transmitted by the dSTAs and determine which Z MHz subchannel is not protected.
4) The relay STA can transmit a TBD3 frame in certain subchannels. In an embodiment, the certain subchannels are determined based on the protected subchannels among the relay STA and dSTAs. In an embodiment, the certain subchannels are determined based on the receive power of CTS frames in each Z MHz subchannel.
5) In mm-Wave systems, a small number of users (e.g., two users) for MU transmission is considered due to small rank.
6) In mm-Wave systems, a CTS frame may pass through a strong loss of signal (LoS) path (i.e., multi-path property is weak).

Steps for implicitly determining CBQR information in a relay system when the relay STA does not transmit a MU-RTS trigger frame are now described.
Step 1: The AP may transmit a MU-RTS frame to dSTA1 and dSTA2. In this example, it is assumed that the RU allocation fields included in the MU-RTS frame are set to P20 for STA1 and P40 for STA2. The AP may wait for a time to receive both a CTS frame and a TBD3 frame.

The remaining steps may be the same as steps 2a-6a, 2b-6b, 2c-6c, or 2d-6d of Scenario 1-1 described above.

In the implicit CBQR determination techniques described above, whether to transmit a frame with an implicit CBQR method can be indicated. In the implicit CBQR determination techniques described above, the capability of whether transmission of a frame according to implicit CBQR techniques is supported can be announced/reported beforehand.

Using the explicit CBQR technique described above, a STA that receives an explicit CBQR can obtain more precise information compared to the implicit CBQR technique described above in general scenarios (e.g., high rank scenarios and CBQR for a large number of STAs). The implicit CBQR technique can obtain just as precise information as explicit CBQR in certain scenarios (e.g., low rank scenarios and CBQR for a small number of STAs). The implicit CBQR technique may have lower transmission overhead compared to the explicit CBQR technique.

Techniques are described herein for a STA (e.g., a relay STA or a shared AP) to provide information regarding the availability of each subchannel at other STAs (e.g., dSTAs or STAs that are associated with the shared AP) to another STA (e.g., an associated AP of the relay STA or a sharing AP). By using the techniques described herein, the AP in a relay system can allocate MU resources in a more efficient manner (e.g., so that resources are not wasted or underutilized). This improves the rate-vs-range performance of relay operations in the relay system Also, by using the techniques described herein, a sharing AP in a multi-AP system can allocate resources for a shared TXOP in a more efficient manner (e.g., so that resources are not wasted or underutilized). This improves network throughput in the multi-AP system.

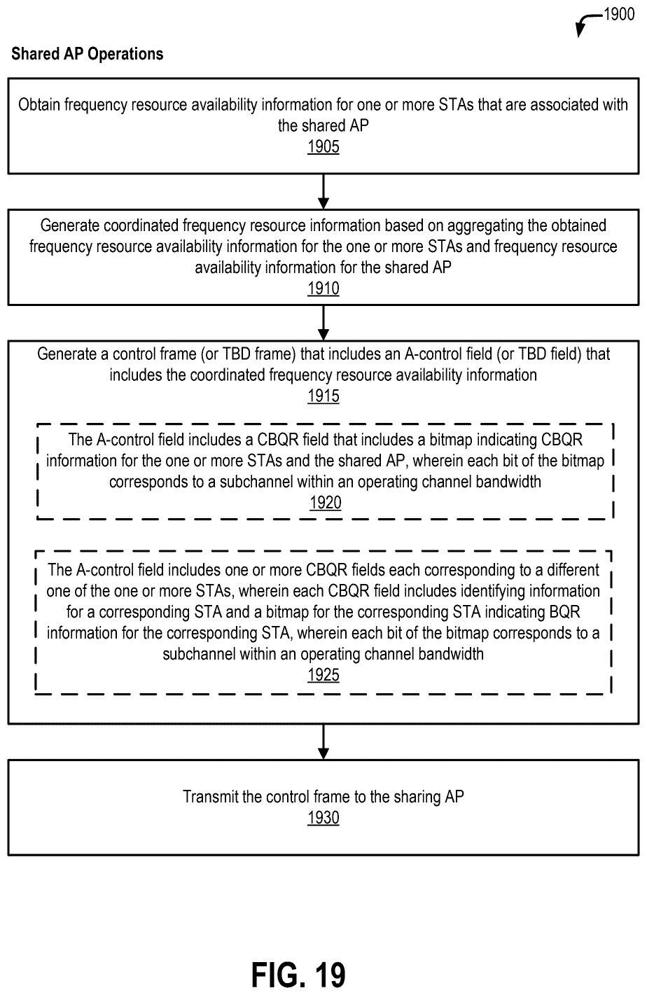

Turning now to FIG. 19, a method 1900 will be described for providing coordinated frequency resource information to a sharing AP, in accordance with an example embodiment. The method 1900 may be performed by a shared AP. The shared AP may be implemented by a wireless device (e.g., wireless device 104).

Additionally, although shown in a particular order, in some embodiments the operations of the method 1900 (and the other methods shown in the other figures) may be performed in a different order. For example, although the operations of the method 1900 are shown in a sequential order, some of the operations may be performed in partially or entirely overlapping time periods.

At operation 1905, the shared AP obtains frequency resource availability information for one or more STAs that are associated with the shared AP.

At operation 1910, the shared AP generates coordinated frequency resource information based on aggregating the obtained frequency resource availability information for the one or more STAs and frequency resource availability information for the shared AP. In an embodiment, the coordinated frequency resource information includes one or more of: coordinated subchannel availability information, coordinated maximum available bandwidth information, and coordinated punctured channel information.

At operation 1915, the shared AP generates a control frame (or TBD frame) that includes an A-control field (or TBD field) that includes the coordinated frequency resource availability information.

In an embodiment, as shown in block 1920, the A-control field includes a CBQR field that includes a bitmap indicating CBQR information for the one or more STAs and the shared AP, wherein each bit of the bitmap corresponds to a subchannel within an operating channel bandwidth. In an embodiment, a bit of the bitmap is set to a value of ‘1’ if a corresponding subchannel is available at the shared AP and all of the one or more STAs and is otherwise set to a value of ‘0’. In an embodiment, a bit of the bitmap is set to a value of ‘1’ if a corresponding subchannel is available at all of the one or more STAs and is otherwise set to a value of ‘0’. In such an embodiment, the A-control field may further include a BQR field that includes a bitmap indicating BQR information for the shared AP. In an embodiment, the bitmap includes eight bits. In such an embodiment, when the operating channel bandwidth is Z*16 and the A-control field includes a single CBQR field, the single CBQR field may apply to a primary Z*8 bandwidth of the operating channel bandwidth, wherein Z is a subchannel size. When the operating channel bandwidth is Z*16 and the A-control field includes two CBQR fields, a first CBQR field may apply to a primary Z*8 bandwidth of the operating channel bandwidth and a second CBQR field may apply to a secondary Z*8 bandwidth of the operating channel bandwidth, wherein Z is a subchannel size.

In an embodiment, as shown in block 1925, the A-control field includes one or more CBQR fields each corresponding to a different one of the one or more STAs, wherein each CBQR field includes identifying information for a corresponding STA and a bitmap for the corresponding STA indicating BQR information for the corresponding STA, wherein each bit of the bitmap corresponds to a subchannel within an operating channel bandwidth. In an embodiment, a bit of the bitmap for a STA is set to a value of ‘1’ if a subchannel corresponding to the bit is available at the STA and is otherwise set to a value of ‘0’. In an embodiment, the bitmap for a STA includes eight bits. In such an embodiment, when the operating channel bandwidth is Z*16 and the A-control field includes a single CBQR field for a STA, the single CBQR field for the STA may apply to a primary Z*8 bandwidth of the operating channel bandwidth, wherein Z is a subchannel size. When the operating channel bandwidth is Z*16 and the A-control field includes two CBQR fields for a STA, a first CBQR field for the STA may apply to a primary Z*8 bandwidth of the operating channel bandwidth and a second CBQR field for the STA may apply to a secondary Z*8 bandwidth of the operating channel bandwidth, wherein Z is a subchannel size. In an embodiment, the bitmap for a STA includes sixteen bits and the operating channel bandwidth is Z*16, wherein Z is a subchannel size.

At operation 1930, the shared AP transmits the control frame to the sharing AP.

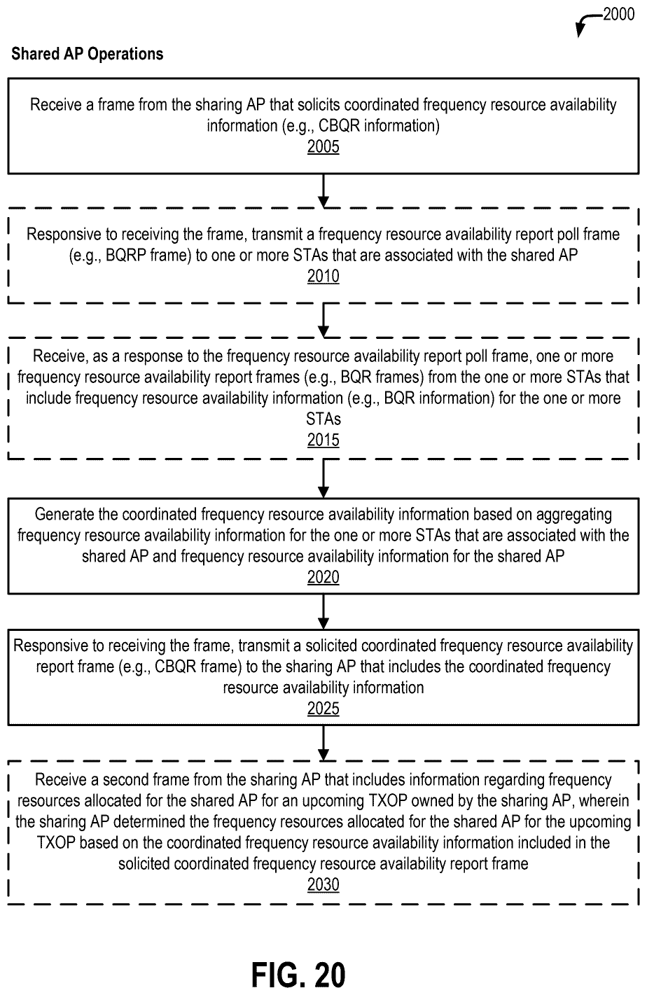

Turning now to FIG. 20, a method 2000 will be described for providing coordinated frequency resource availability information to a sharing AP, in accordance with an example embodiment. The method 2000 may be performed by a shared AP. The shared AP may be implemented by a wireless device (e.g., wireless device 104).

At operation 2005, the shared AP receives a frame from the sharing AP that solicits coordinated frequency resource availability information (e.g., CBQR information).

In an embodiment, at operation 2010, responsive to receiving the frame, the shared AP transmits a frequency resource availability report poll frame (e.g., BQRP frame) to one or more STAs that are associated with the shared AP.

In an embodiment, at operation 2015, the shared AP receives, as a response to the frequency resource availability report poll frame, one or more frequency resource availability report frames (e.g., BQR frames) from the one or more STAs that include frequency resource availability information (e.g., BQR information) for the one or more STAs.

At operation 2020, the shared AP generates the coordinated frequency resource availability information based on aggregating frequency resource availability information for the one or more STAs that are associated with the shared AP and frequency resource availability information for the shared AP. In an embodiment, the coordinated frequency resource availability information includes one or more of: coordinated subchannel availability information, coordinated maximum available bandwidth information, and coordinated punctured channel information.

At operation 2025, responsive to receiving the frame, the shared AP, transmits a solicited coordinated frequency resource availability report frame (e.g., CBQR frame) to the sharing AP that includes the coordinated frequency resource availability information.

In an embodiment, at operation 2030, the shared AP receives a second frame from the sharing AP that includes information regarding frequency resources allocated for the shared AP for an upcoming TXOP owned by the sharing AP, wherein the sharing AP determined the frequency resources allocated for the shared AP for the upcoming TXOP based on the coordinated frequency resource availability information included in the solicited coordinated frequency resource availability report frame.

In an embodiment, the shared AP transmits an unsolicited coordinated frequency resource availability report frame that includes coordinated frequency resource availability information to the sharing AP during a multi-AP coordination setup procedure.

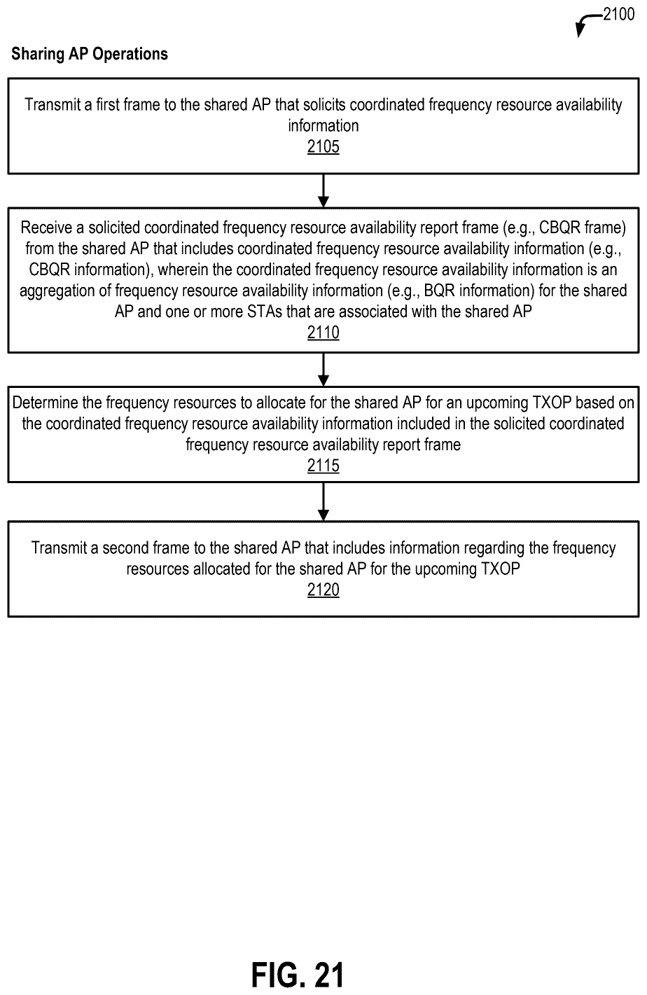

Turning now to FIG. 21, a method 2100 will be described for allocating frequency resources for a shared AP for an upcoming transmission opportunity (TXOP) owned by a sharing AP, in accordance with an example embodiment. The method 2100 may be performed by a sharing AP. The sharing AP may be implemented by a wireless device (e.g., wireless device 104).

At operation 2105, the sharing AP transmits a first frame to the shared AP that solicits coordinated frequency resource availability information. In an embodiment, the first frame triggers the shared AP to transmit a frequency resource availability report poll frame to the one or more STAs.

At operation 2110, the sharing AP receives a solicited coordinated frequency resource availability report frame (e.g., CBQR frame) from the shared AP that includes coordinated frequency resource availability information (e.g., CBQR information), wherein the coordinated frequency resource availability information is an aggregation of frequency resource availability information (e.g., BQR information) for the shared AP and one or more STAs that are associated with the shared AP. In an embodiment, the coordinated frequency resource availability information includes one or more of: coordinated subchannel availability information (e.g., CBQR information), coordinated maximum available bandwidth information, and coordinated punctured channel information.

At operation 2115, the sharing AP determines the frequency resources to allocate for the shared AP for an upcoming TXOP based on the coordinated frequency resource availability information included in the solicited coordinated frequency resource availability report frame.

At operation 2120, the sharing AP transmits a second frame to the shared AP that includes information regarding the frequency resources allocated for the shared AP for the upcoming TXOP.

In an embodiment, the sharing AP receives an unsolicited coordinated frequency resource availability report frame from the shared AP that includes coordinated frequency resource availability information during a multi-AP coordination setup procedure.

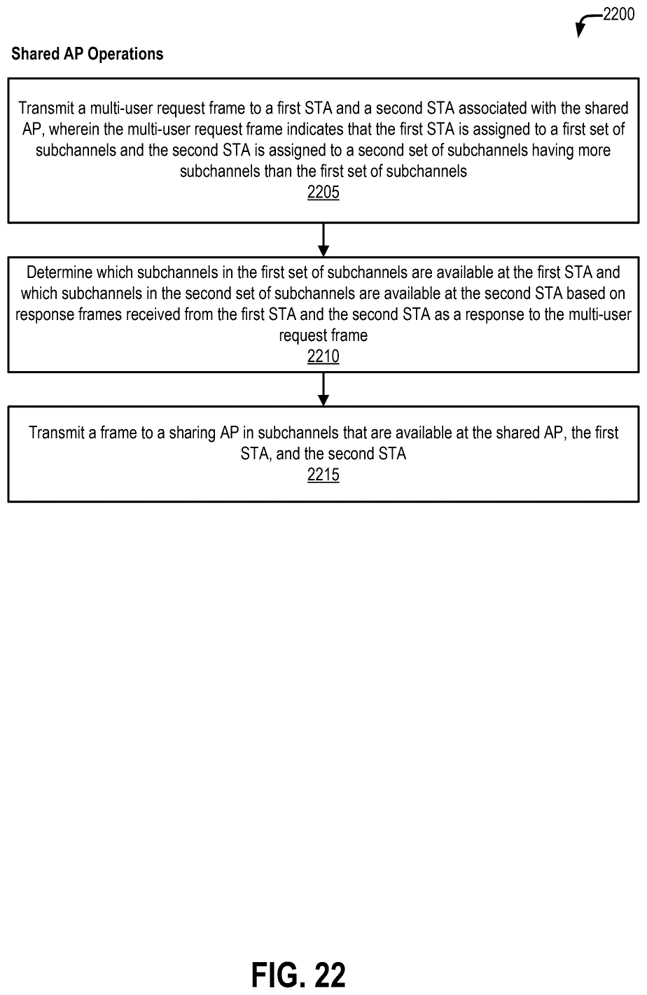

Turning now to FIG. 22, a method 2200 will be described for providing coordinated frequency resource availability information to a sharing AP, in accordance with an example embodiment. The method 2000 may be performed by a shared AP. The shared AP may be implemented by a wireless device (e.g., wireless device 104).

At operation 2205, the shared AP transmits a multi-user request frame to a first STA and a second STA associated with the shared AP, wherein the multi-user request frame indicates that the first STA is assigned to a first set of subchannels and the second STA is assigned to a second set of subchannels having more subchannels than the first set of subchannels.

At operation 2210, the shared AP determines which subchannels in the first set of subchannels are available at the first STA and which subchannels in the second set of subchannels are available at the second STA based on response frames received from the first STA and the second STA as a response to the multi-user request frame. In an embodiment, the multi-user request frame is a MU-RTS frame and the response frames are per-subchannel CTS frames.

At operation 2215, the shared AP transmits a frame to a sharing AP in subchannels that are available at the shared AP, the first STA, and the second STA.

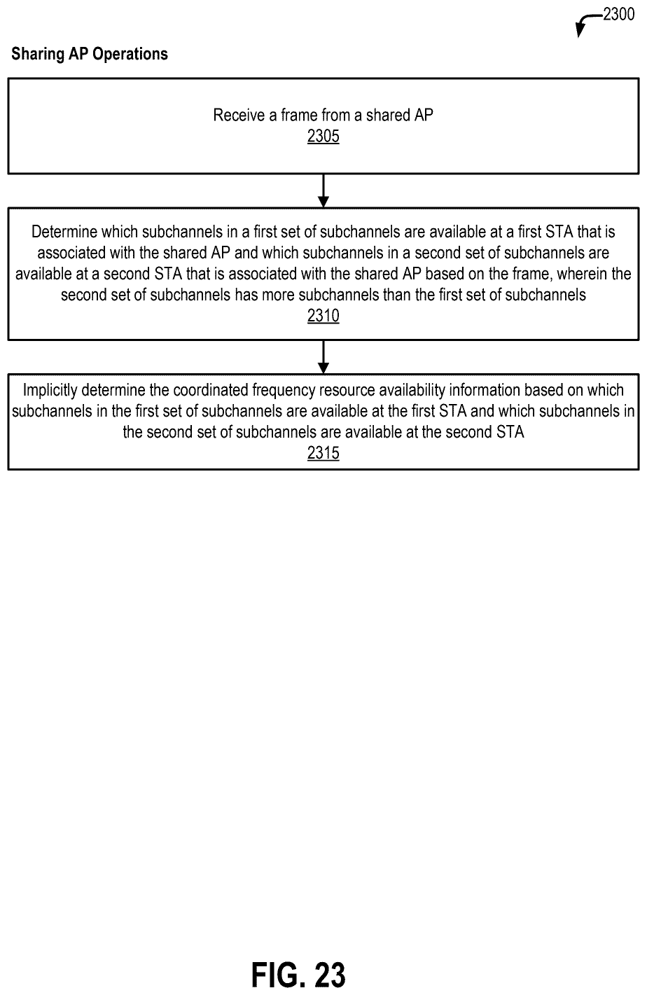

Turning now to FIG. 23, a method 2300 will be described for implicitly determining coordinated frequency resource availability information provided by a shared AP, in accordance with an example embodiment. The method 2300 may be performed by a sharing AP. The sharing AP may be implemented by a wireless device (e.g., wireless device 104).

At operation 2305, the sharing AP receives a frame from a shared AP.

At operation 2310, the sharing AP determines which subchannels in a first set of subchannels are available at a first STA that is associated with the shared AP and which subchannels in a second set of subchannels are available at a second STA that is associated with the shared AP based on the frame, wherein the second set of subchannels has more subchannels than the first set of subchannels. In an embodiment, the determining comprises determining whether the frame was received in each subchannel and a received signal strength of the frame in each subchannel in which the frame was received.

At operation 2315, the sharing AP implicitly determines the coordinated frequency resource availability information based on which subchannels in the first set of subchannels are available at the first STA and which subchannels in the second set of subchannels are available at the second STA.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a shared access point (AP) to provide coordinated frequency resource information to a sharing AP, the method comprising:
obtaining frequency resource availability information for one or more stations (STAs) that are associated with the shared AP;
generating the coordinated frequency resource information based on aggregating the obtained frequency resource availability information for the one or more STAs and frequency resource availability information for the shared AP;
generating a control frame that includes an aggregated control (A-control) field that includes the coordinated frequency resource availability information; and
transmitting the control frame to the sharing AP.

2. The method of claim 1, wherein the coordinated frequency resource information is coordinated bandwidth query report (CBQR) information, wherein the A-control field includes a CBQR field that includes a bitmap indicating CBQR information for the one or more STAs and the shared AP, wherein each bit of the bitmap corresponds to a subchannel within an operating channel bandwidth.

3. The method of claim 2, wherein a bit of the bitmap is set to a value of ‘1’ if a corresponding subchannel is available at the shared AP and all of the one or more STAs and is otherwise set to a value of ‘0’.

4. The method of claim 2, wherein a bit of the bitmap is set to a value of ‘1’ if a corresponding subchannel is available at all of the one or more STAs and is otherwise set to a value of ‘0’.

5. The method of claim 4, wherein the A-control field further includes a bandwidth query report (BQR) field that includes a bitmap indicating bandwidth query report information for the shared AP.

6. The method of claim 2, wherein the bitmap includes eight bits.

7. The method of claim 6, wherein when the operating channel bandwidth is Z*16 and the A-control field includes a single CBQR field, the single CBQR field applies to a primary Z*8 bandwidth of the operating channel bandwidth, wherein Z is a subchannel size.

8. The method of claim 6, wherein when the operating channel bandwidth is Z*16 and the A-control field includes two CBQR fields, a first CBQR field applies to a primary Z*8 bandwidth of the operating channel bandwidth and a second CBQR field applies to a secondary Z*8 bandwidth of the operating channel bandwidth, wherein Z is a subchannel size.

9. The method of claim 1, wherein the coordinated frequency resource information is coordinated bandwidth query report (CBQR) information, wherein the A-control field includes one or more CBQR fields each corresponding to a different one of the one or more STAs, wherein each CBQR field includes identifying information for a corresponding STA and a bitmap for the corresponding STA indicating bandwidth query report (BQR) information for the corresponding STA, wherein each bit of the bitmap corresponds to a subchannel within an operating channel bandwidth.

10. The method of claim 9, wherein a bit of the bitmap for a STA is set to a value of ‘1’ if a subchannel corresponding to the bit is available at the STA and is otherwise set to a value of ‘0’.

11. The method of claim 9, wherein the bitmap for a STA includes eight bits.

12. The method of claim 11, wherein when the operating channel bandwidth is Z*16 and the A-control field includes a single CBQR field for a STA, the single CBQR field for the STA applies to a primary Z*8 bandwidth of the operating channel bandwidth, wherein Z is a subchannel size.

13. The method of claim 11, wherein when the operating channel bandwidth is Z*16 and the A-control field includes two CBQR fields for a STA, a first CBQR field for the STA applies to a primary Z*8 bandwidth of the operating channel bandwidth and a second CBQR field for the STA applies to a secondary Z*8 bandwidth of the operating channel bandwidth, wherein Z is a subchannel size.

14. The method of claim 9, wherein the bitmap for a STA includes sixteen bits and the operating channel bandwidth is Z*16, wherein Z is a subchannel size.

15. The method of claim 1, wherein the coordinated frequency resource information includes one or more of: coordinated subchannel availability information, coordinated maximum available bandwidth information, and coordinated punctured channel information.

16. A method performed by a shared access point (AP) to provide coordinated frequency resource availability information to a sharing AP, the method comprising:
receiving a frame from the sharing AP that solicits the coordinated frequency resource availability information;
generating the coordinated frequency resource availability information based on aggregating frequency resource availability information for one or more STAs that are associated with the shared AP and frequency resource availability information for the shared AP; and
responsive to receiving the frame, transmitting a solicited coordinated frequency resource availability report frame to the sharing AP that includes the coordinated frequency resource availability information.

17. The method of claim 16, further comprising:
further responsive to receiving the frame, transmitting a frequency resource availability report poll frame to the one or more STAs; and
receiving, as a response to the frequency resource availability report poll frame, one or more frequency resource availability report frames from the one or more STAs that include the frequency resource availability information for the one or more STAs.

18. The method of claim 16, further comprising:
receiving a second frame from the sharing AP that includes information regarding frequency resources allocated for the shared AP for an upcoming transmission opportunity (TXOP) owned by the sharing AP, wherein the sharing AP determined the frequency resources allocated for the shared AP for the upcoming TXOP based on the coordinated frequency resource availability information included in the solicited coordinated frequency resource availability report frame.

19. The method of claim 16, further comprising:
transmitting an unsolicited coordinated frequency resource availability report frame that includes coordinated frequency resource availability information to the sharing AP during a multi-AP coordination setup procedure.

20. The method of claim 16, wherein the coordinated frequency resource availability information includes one or more of: coordinated subchannel availability information, coordinated maximum available bandwidth information, and coordinated punctured channel information.

21. A method performed by a sharing access point (AP) to allocate frequency resources to a shared AP for an upcoming transmission opportunity (TXOP) owned by the sharing AP, the method comprising:
transmitting a first frame to the shared AP that solicits coordinated frequency resource availability information;
receiving, as a response to the first frame, a solicited coordinated frequency resource availability report frame from the shared AP that includes coordinated frequency resource availability information, wherein the coordinated frequency resource availability information is an aggregation of frequency resource availability information for the shared AP and one or more STAs that are associated with the shared AP;
determining the frequency resources to allocate for the shared AP for the upcoming TXOP based on the coordinated frequency resource availability information included in the solicited coordinated frequency resource availability report frame; and
transmitting a second frame to the shared AP that includes information regarding the frequency resources allocated for the shared AP for the upcoming TXOP.

22. The method of claim 21, wherein the first frame triggers the shared AP to transmit a frequency resource availability report poll frame to the one or more STAs.

23. The method of claim 21, further comprising:
receiving an unsolicited coordinated frequency resource availability report frame from the shared AP that includes coordinated frequency resource availability information during a multi-AP coordination setup procedure.

24. The method of claim 21, wherein the coordinated frequency resource availability information includes one or more of: coordinated subchannel availability information, coordinated maximum available bandwidth information, and coordinated punctured channel information.

25. A method performed by a shared access point (AP) to provide coordinated frequency resource availability information to a sharing AP, the method comprising:
transmitting a multi-user request frame to a first station (STA) and a second STA associated with the shared AP, wherein the multi-user request frame indicates that the first STA is assigned to a first set of subchannels and the second STA is assigned to a second set of subchannels having more subchannels than the first set of subchannels;
determining which subchannels in the first set of subchannels are available at the first STA and which subchannels in the second set of subchannels are available at the second STA based on response frames received from the first STA and the second STA as a response to the multi-user request frame; and
transmitting a frame to a sharing AP in subchannels that are available at the shared AP, the first STA, and the second STA.

26. The method of claim 25, wherein the multi-user request frame is a multi-user request-to-send (MU-RTS) frame and the response frames are per-subchannel clear-to-send (CTS) frames.

27. A method performed by a sharing access point (AP) to implicitly determine coordinated frequency resource availability information provided by a shared AP, the method comprising:
receiving a frame from the shared AP;
determining which subchannels in a first set of subchannels are available at a first station (STA) that is associated with the shared AP and which subchannels in a second set of subchannels are available at a second STA that is associated with the shared AP based on the frame, wherein the second set of subchannels has more subchannels than the first set of subchannels; and
implicitly determining the coordinated frequency resource availability information based on which subchannels in the first set of subchannels are available at the first STA and which subchannels in the second set of subchannels are available at the second STA.

28. The method of claim 27, wherein the determining comprises determining whether the frame was received in each subchannel and a received signal strength of the frame in each subchannel in which the frame was received.
